(19) United States
(12) Patent Application Publication
(10) Pub. No.: US 2007/0011022 A1
(43) Pub. Date: Jan. 11, 2007

(54) System and method of applying databases to mobile sales

(76) Inventors: Gerald V. Wright JR., Solana Beach, CA (US); Scott Herndon, San Diego, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/438,910

(22) Filed: May 23, 2006

Related U.S. Application Data
(60) Provisional application No. 60/684,495, filed on May 24, 2005.

(51) Int. Cl. G06Q 30/00

(52) U.S. Cl. 705/1

(57) ABSTRACT

A system and method for provisioning sales related application modules and data to mobile devices for users. The application modules provide users with access to information useful during the sales process, such as product features, specifications, comparisons, pricing, and inventory. The applications and data reside on the mobile device and are updated during automated wireless connections between the mobile device and a central server. The server includes a database that stores the sales related information, which can be entered into the system manually or retrieved automatically from remote computers. The system provides administrative functions that allow a user to define a sales location, including an associated set of products available for sale, and an associated set of salesperson users. Administrators may also designate application modules for use at individual locations, or by individual users, and may view various reports based on application module usage data collected from the mobile devices.

### CROSS-REFERENCE TO RELATED APPLICATIONS

This application claims the benefit under 35 U.S.C. § 119(e) of U.S. Patent Application No. 60/684,495 filed May 24, 2005, for “Mobile Sales Assistant System”, which is hereby incorporated by reference.

### BACKGROUND OF THE INVENTION

1. Field of the Invention

The invention relates to applying databases in the field of databases, and more particularly, to applying databases to mobile sales.

2. Description of the Related Art

One of the major challenges in retail sales is providing good customer service—being able to answer customer questions quickly, accurately, and professionally. This challenge has become more difficult in recent years as the result of several trends: consumers have become accustomed to the immediacy and accuracy of the Internet and are harder to please; the number of product models available has increased to serve increasingly smaller niche markets; and technology has made many classes or products harder to explain, differentiate, and sell. Although consumers have benefited greatly through these trends, retailers (and retail salespeople specifically), now have a much harder job. They have much more information to learn, and less time to present it.

To meet this challenge, many retailers provide computers for use on the retail floor. However, in many classes of trade, such as automobiles, it is not feasible or convenient for a salesperson to use these computers because they are not available where the salesperson comes into contact with a customer. For example, in automotive sales, the salesperson interacts with a customer on the lot, in the showroom, or even on a test drive. The automotive salesperson may even field customer calls on a day off from their job. Today's retail salesperson requires a comprehensive reference tool that they can carry with them and use at the point of contact with the customer.

### SUMMARY OF THE INVENTION

The system and method utilizes databases and a wireless mobile computing device, such as a personal digital assistant (PDA), smartphone, or other device, to provide retail salespeople with a comprehensive sales information resource that is accessible anytime and anywhere. The mobile device is equipped with software that maintains detailed product features, specifications, competitive comparisons, pricing, inventory, and other related sales data. In certain embodiments, the applications and data reside on the mobile device itself, allowing the device to be used in areas without network coverage, such as on a test drive in an automotive sales environment. When network coverage is available, the application automatically retrieves available updates, ensuring that data is up to date wherever wireless network connectivity is available.

The system and method can be implemented quickly and easily and does not require any software to be installed at a retailer. The system uses wireless network access, wireless mobile devices, and a retailer account to be created in the system. In certain embodiments, once the retailer account has been created, sales management personnel can log in to the system to create user accounts for individual salespeople. Next, salespeople can download and install the application directly from the mobile device web browser.

In one embodiment, there is a system for applying databases to provide product related information to mobile users, the system comprising a wireless communications network configured to provide coverage at retail locations; a portable computing device configured to be intermittently connected to the wireless communications network, wherein the portable computing device includes a data repository configured to store inventory information, a software application comprising various modules including an inventory module configured to display inventory information based on the data repository, and a communications module configured to retrieve updates to the portable device software application and inventory information; a server computer having a network connection to the wireless communications network, and at least one external server computer, the server computer comprising a server data repository configured to store (1) location profiles for each location where portable devices are used, each location profile including identifying information and information required to access an inventory system of a particular location, (2) portable device user profiles including identifying information, each user profile being associated with a location profile, and (3) inventory information retrieved from the inventory system of the particular location, a communications module configured to connect with the portable computing device so as to provide updates, a location module configured to manage location profiles, a user module configured to manage portable device profiles, and an inventory module configured to (1) retrieve inventory information from the inventory system of the particular location using access information stored in the location profile, (2) store inventory information in the server data repository, and (3) display inventory information; and a computing device configured to remotely use the user module and the location module located on the server computer.

One of the retail locations may be an automobile dealer. The computing device may access various server modules via a communications network. The server computer may additionally comprise a reporting module configured to summarize software application usage data, where the computing device may be configured to remotely use the reporting module. The inventory information may include product information and the products may be vehicles.

The portable computing device may be configured to receive data entered by a user. The data entered by the user may comprise a note associated with a particular product in inventory. The data entered by the user may comprise an attribute associated with a particular product in inventory, where the attribute may comprise a location of a particular product. The portable computing device may be configured to display data entered by other portable device users. The data repository on the portable device may be further configured to store information entered by a user. The server data repository may be additionally configured to store information entered by portable device users associated with the particular location. The portable computing device communications module may be further configured to send data entered by the user. The portable computing device communications module may be further configured to retrieve data entered by other portable device users associated with the particular location. The server computer communications module may be further configured to retrieve data entered by the user. The server computer communications module may be further configured to send data entered by other portable device users associated with the particular location. The server inventory module may be configured to display data entered on any portable computing device associated with the particular location. Various modules within the server computer may display information entered by portable device users associated with the particular location. The server computer inventory module may be further configured to display notes and location changes entered by portable device users associated with the particular location. The computing device may be additionally configured to access the inventory module on the server computer.

The portable device application may include one or more modules configured to display product related information. The product related information may include product features and specifications, or may include comparisons between various products, or may include product configuration information. The portable device communications module may retrieve updates to product related information. The server communications module may send updates to product related information. The portable device data repository may be further configured to store product related information. The server computer may include one or more product data modules configured to control what product information is sent to portable computing devices. The user may define comparison relationships between specific products. The computing device may be additionally configured to access the product data modules on the server. The server data repository may be further configured to store product related information retrieved from various sources including data sources located on the external server computer.

One of the application modules may be configured to configure and price a product by displaying a plurality of product options, wherein valid combinations of such product options are determined by a set of fixed rules.

The portable device software application may include a module configured to display messages. The portable device data repository may be further configured to store messages. The server computer data repository may be further configured to store messages. The portable device communications module may retrieve messages. The server communications module may send messages. The server computer may include a messaging module configured to send messages to portable device users. The server computer messaging module may be further configured to monitor when messages or bulletins sent to users are read by the users. The computing device may be additionally configured to allow a user to access the messaging module on the server.

The portable device data repository may be further configured to store application usage data. One of the application modules may be configured to configure and price a product by displaying a plurality of product options, wherein valid combinations of such product options are determined by a set of fixed rules. The application usage data may include data entered using the configuration module. The portable device application may include one or more modules configured to display product related information. The application usage data may include the data accessed using a product data module. The application usage data may include items in inventory selected by the user from the inventory module. The portable device software application may include a module configured to display messages. The application usage data may include the time messages are read in the messaging module. The server data repository may be configured to store application usage data received from the portable computing device. The portable device communications module may send application usage data to the server. The server communications module may retrieve usage data from the portable computing device. The server may include a reporting module configured to display application usage data. The computing device may be additionally configured to allow a user to access the reporting module on the server.

One of the location profiles stored in the server data repository may include a list of modules and functions authorized for use on the portable computing device associated with the particular location. One of the user profiles stored in the server data repository may include a list of modules and functions authorized for use on a portable computing device associated with the particular location. Portable device functionality may be limited to that specified in the location profile. Portable device functionality may be additionally limited to that specified in one of the user profiles. Portable device functionality may be limited to that specified in one of the user profiles that is associated with the particular location.

In another embodiment, there is a system for configuring and calculating the price of a product with multiple options, the system comprising a portable computing device with a wireless data communications capability comprising a data repository containing product models, available product options, and rules that define relationships between the product options, and a software application configured to allow a user to select the various options for a particular product, such that at all times during use, all the available options are visible, but only options that represent valid selections based on the rules can be selected.

One of the rules may describe the relationship between the options, wherein one option, when selected, includes a selection of a plurality of other options. One of the rules may describe the relationship between options, wherein one option cannot be selected until a plurality of other options has first been selected. One of the rules may describe the relationship between options, wherein one option cannot be selected until one of a plurality of other options has first been selected. One of the rules may describe the relationship between options, wherein one option, when selected, renders a plurality of other options unavailable for selection.

In another embodiment, there is a method of configuring and calculating the price of a product with multiple options, the method comprising operating a portable computing device with a wireless data communications capability; providing a data repository containing product models, available product options, and rules that define relationships between the product options; and selecting the various options for a particular product, wherein at all times during use, all the available options are visible, but only options that represent valid selections based on the rules can be selected.

In another embodiment, there is a method of displaying text in a complete and abbreviated form operating in a system comprising a portable computing device with a display and a user input device and including an application executing on the portable device that designates a plurality of display areas on the screen to display text and a data storage comprising a plurality of text items to be displayed such that some of the text items are too long to be drawn in a display area, the method comprising displaying only a portion of text that, in conjunction with an abbreviation marker, fits in the display area; selecting the display area; and displaying a complete form of the text in a larger display area, comprising dynamically calculating the larger display's size based on the length of the complete text, and automatically removing the complete form of the text from the larger display area after an amount of time proportionate to the length of the complete text.

The abbreviation marker may comprise an ellipses character appended to the abbreviated text. The abbreviation marker may comprise a typographically stylized form of the abbreviated text. The abbreviation marker may comprise a stylized background or border of the abbreviated text display area.

In another embodiment, there is a system for providing product related information to mobile users in a retail location, the system comprising a wireless communications network configured to provide coverage at retail location; and a plurality of portable computing devices, wherein each portable computing device is configured to be intermittently connected to the wireless communications network, and wherein each portable computing device includes a means for entering data, a data repository configured to store inventory information, data entered by the user, product related information, and application usage information, and a software application comprising various modules including an inventory module configured to display inventory information based on the data repository, a product data module configured to display product related information, and a communications module configured to (1) retrieve updates to the portable device application, (2) retrieve updates to inventory data, (3) retrieve updates to product related information, (4) retrieve data stored on another portable computing device, (5) send information entered by the user, and (6) send application usage information. The retail location may be an automobile dealership.

The inventory module may be further configured to allow the user to enter a note associated with a particular product in inventory. The inventory module may be further configured to allow the user to modify an attribute of a particular product in inventory, where the attribute may comprise a location of a particular product.

The product related information may include product features and specifications, or may include comparisons between various products, or may include product configuration information.

The portable device software application may additionally comprise a configuration module configured to configure and price a product by displaying a plurality of product options, wherein valid combinations of such product options are determined by a set of fixed rules. The application usage information may include data entered using the configuration module.

The portable device software application may include a messaging module configured to display messages. The application usage information may include the time and date messages are read in the messaging module. The portable device data repository may be further configured to store messages. The portable device communications module may retrieve messages.

The application usage information may include information accessed using the product data module. The product data module may be a single product data module. The product data module may comprise a plurality of product data modules. The application usage information may include items in inventory selected by the user from the inventory module.

In another embodiment, there is a system for providing product related information to mobile users in a plurality of retail locations, the system comprising a wireless communications network configured to provide coverage at retail locations; and a server computer having a network connection to the wireless communications network, and at least one external server computer, the server computer comprising a server data repository configured to store (1) location profiles for each location where portable devices are used, each location profile including identifying information and information required to access an inventory system of a particular location, (2) portable device user profiles including identifying information, each user profile being associated with a location profile, and (3) inventory information retrieved from the inventory system of the particular location, a communications module configured to connect with the portable computing device so as to send inventory information updates, a location module configured to manage location profiles, a user module configured to manage portable device profiles, and an inventory module configured to (1) retrieve inventory information from the inventory systems of the particular location using access information stored in the location profile, (2) store inventory information in the data repository, and (3) display inventory data. One of the retail locations may be an automobile dealership. The products may be vehicles.

The server data repository may be additionally configured to store information entered by portable device users. The server computer communications module may be further configured to retrieve data entered by portable device users. The server computer communications module may be further configured to send data retrieved from portable devices associated with the particular location. Various modules within the server computer may display information entered by portable device users. The server inventory module may be further configured to display data entered on a portable device. The server computer inventory module may be further configured to display notes and location changes entered by portable device users.

The server data repository may be further configured to store product related information retrieved from various sources including data sources located on the external server computer. The product related information may include product features and specifications, or may include comparisons between various products, or may include product configuration information. The server computer may include one or more product data modules configured to control the product related information that is sent to portable computing devices, where the user may define comparison relationships between specific products. The server communications module may send updates of the product related information.

The server computer data repository may be further configured to store messages. The server communications module may be further configured to send messages. The server computer may include a messaging module configured to send messages to portable device users. The server computer messaging module may be further configured to monitor when messages or bulletins sent to users are read by the users.

One of the location profiles stored in the server data repository may include modules and functions authorized for use on a portable computing device associated with the particular location. One of the user profiles stored in the server data repository may include modules and functions authorized for use on a portable computing device associated with the particular location.

In yet another embodiment, there is a method of prompting a user for a selection of an item from a set of items defined by a database query, and maintaining a currently selected item, the method operating in a system comprising a portable computing device with a display, a user input device, data storage and including an application executing on the portable device, the method comprising designating a currently selected item from a set of items in a database defined by a query, displaying the currently selected item, receiving a selected function to change the currently selected item, displaying available choices associated with the currently selected item in a hierarchical menu structure, receiving a newly selected item from the hierarchical menu structure, displaying the newly selected item in an item display area on the display, and storing the newly selected item. A stored selection can be associated with an item in the database query, and the associated item is designated as the currently selected item. Alternatively, a stored selection cannot be associated with an item in the database query, and a placeholder is designated as the currently selected item. The application may comprise a function allowing a user to view the hierarchical menu, and a function allowing the user to select an item to be a newly selected item from the hierarchical menu.

### BRIEF DESCRIPTION OF THE DRAWINGS

FIG. 1 is a block diagram illustrating components of an exemplary embodiment of the Mobile Sales Assistant (MSA) system;

FIG. 2 is a block diagram illustrating exemplary software components of the mobile device and the MSA server shown on FIG. 1;

FIG. 3 is a block diagram illustrating exemplary software components of all other computers shown on FIG. 1;

FIG. 4 is a flow diagram illustrating an exemplary application launch process for the exemplary MSA mobile device application shown in FIG. 2.

FIG. 5 is a flow diagram illustrating the main event loop process shown in FIG. 4.

FIG. 6 is a flow diagram illustrating the handle timer process shown in FIG. 5.

FIG. 7 is a flow diagram illustrating the register user process shown in FIG. 4.

FIG. 8 is a flow diagram illustrating the sync process shown in FIG. 5

FIG. 9 is a block diagram illustrating exemplary data structures used by the model picker interface.

FIG. 10 is a flow diagram illustrating an exemplary model picker initialization process used by the model picker user interface.

FIG. 11 is a flow diagram illustrating an exemplary add menu items process shown in FIG. 10.

FIG. 12 is a flow diagram illustrating an exemplary draw current model process shown in FIG. 10.

FIG. 13 is a block diagram illustrating use of the model picker user interface in a specifications screen from an exemplary embodiment of the MSA mobile on.

FIG. 14 is a block diagram illustrating use of the model picker user interface in a new inventory screen from an exemplary embodiment of the MSA mobile device application.

FIG. 15 is a block diagram illustrating product options for a sample product.

FIG. 16 is a listing of an XML file describing the sample product shown in FIG. 15.

FIG. 17 is a block diagram illustrating the data structures used by the configurator.

FIG. 18 is a block diagram of the object option list data structure maintained by the configurator.

FIG. 19 is a flow diagram illustrating an exemplary configurator launch process.

FIG. 20 is a flow diagram illustrating the configurator event loop process shown in FIG. 19.

FIGS. 21a and 21b are flow diagrams illustrating the draw options process shown in FIG. 19.

FIG. 22 is a flow diagram of the select option process shown in FIG. 19.

FIG. 23 is a flow diagram of the unselect option process shown in FIG. 19.

FIG. 24 is a flow diagram of the draw summary process shown in FIG. 19.

FIGS. 25, 26, 27 and 28 are block diagrams illustrating a usage scenario of an exemplary embodiment of the configurator.

FIG. 29 is a block diagram illustrating mobile device screens containing an exemplary embodiment of the expandable text display.

### DETAILED DESCRIPTION OF CERTAIN EMBODIMENTS

The following detailed description of certain embodiments presents various descriptions of specific embodiments of the invention. However, the invention can be embodied in a multitude of different ways. The terminology used in the description presented herein is not intended to be interpreted in any limited or restrictive manner, simply because it is being utilized in conjunction with a detailed description of certain specific embodiments of the invention. Furthermore, embodiments of the invention may include several novel features, no single one of which is solely responsible for its desirable attributes or which is essential to practicing the inventions herein described.

The system is comprised of various modules, tools, and applications as discussed in detail below. As can be appreciated by one of ordinary skill in the art, each of the modules may comprise various sub-routines, procedures, definitional statements and macros. Each of the modules are typically separately compiled and linked into a single executable program. Therefore, the following description of each of the modules is used for convenience to describe the functionality of the preferred system. Thus, the processes that are undergone by each of the modules may be arbitrarily redistributed to one of the other modules, combined together in a single module, or made available in, for example, a shareable dynamic link library.

The system modules, tools, and applications may be written in any suitable programming language such as, for example, C, C++, C#, BASIC, Visual Basic, Pascal, Ada, Java, HTML, XML, or FORTRAN, and executed on an operating system, such as variants of Windows, Macintosh, UNIX, Linux, VxWorks, or other operating system. C, C++, C#, BASIC, Visual Basic, Pascal, Ada, Java, HTML, XML and FORTRAN are industry standard programming languages for which many commercial compilers can be used to create executable code.

For convenience, the discussion of the preferred embodiment will be organized into the following principal sections: System Overview, Initial Configuration, Mobile Device Functionality, and Server Functionality.

### I. System Overview

A Mobile Sales Assistant (MSA) system is a computer system that aggregates sales-related data from a variety of sources and then intelligently distributes it to a variety of mobile devices for use by salespeople engaged in sales activities with customers. The MSA system also provides various management functions for use by: (1) sales management personnel, (2) manufacturer personnel, and (3) for personnel of the entity that operates and administers the MSA system (MSA provider).

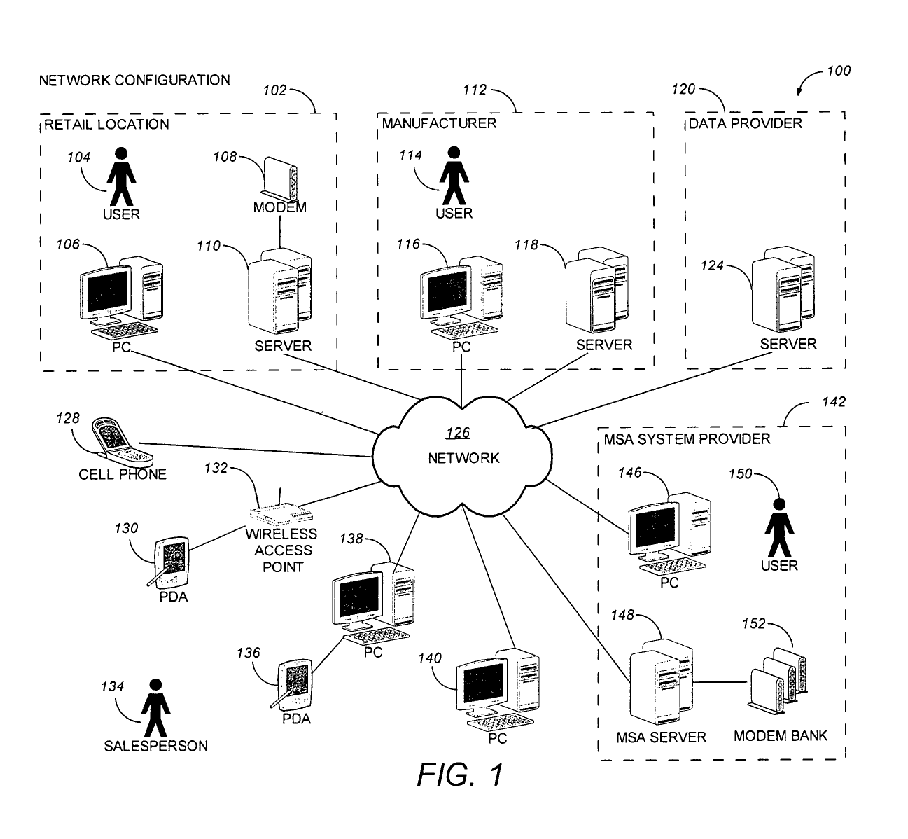

Referring to FIG. 1, a block diagram of an exemplary embodiment of a MSA system 100 will be described. The MSA system 100 includes a network “cloud” 126 that represents a communication network, such as the Internet. Alternatively, the network cloud can represent a private network. The MSA programs and databases preferably reside on a MSA server 148 that is located at a MSA system provider's location 142 and is connected to the Internet. The MSA server is accessed remotely by PCs 106, 116, 146, and 140, which are also connected to the Internet and equipped with web browser software. The MSA server also retrieves and processes data from external systems located at individual retail locations 102, product manufacturers 112, and third-party data providers 120. In the case of retail locations, the MSA server 148 connects to one or more retailer/dealer's servers 110 via the Internet, or alternatively via a modem 108 from a modem bank 152 or via other communication mechanism. In the case of manufacturers, the MSA server 148 retrieves information from a manufacturer server 118 via the Internet. The MSA server also retrieves information from third party data providers by connecting to one or more servers 124 via the Internet. The third party data provider may provide sales-related data such as comparison data, or may be a vendor contracted by an individual retail location or manufacturer to maintain systems where sales related data resides.

In an exemplary embodiment, the MSA provider is a separate business entity from the manufacturer or retailer, providing the MSA system as an application service provider to manufacturers and/or retailers. However, in another embodiment, the MSA system could be owned and operated by a manufacturer or retailer.

Note that when this description refers to a server computer, as in the MSA server 148, the manufacturer server 118, the data provider server 124, and the retail location server 110, that the server may refer to a single server computer or a collection of server computers working to together to provide increased computing capacity and improved fault tolerance.

Various mobile devices also connect to the MSA server 148 via the Internet 126. A cell phone 128 connects to the Internet 126 through the cell phone operator's wireless data network. A wireless PDA 130 connects to a wireless access point 132, which connects to the Internet. A PDA 136 connects to a PC 138 via a serial cable, Bluetooth connection, or Infrared connection, and then connects to the Internet through a PC 138.

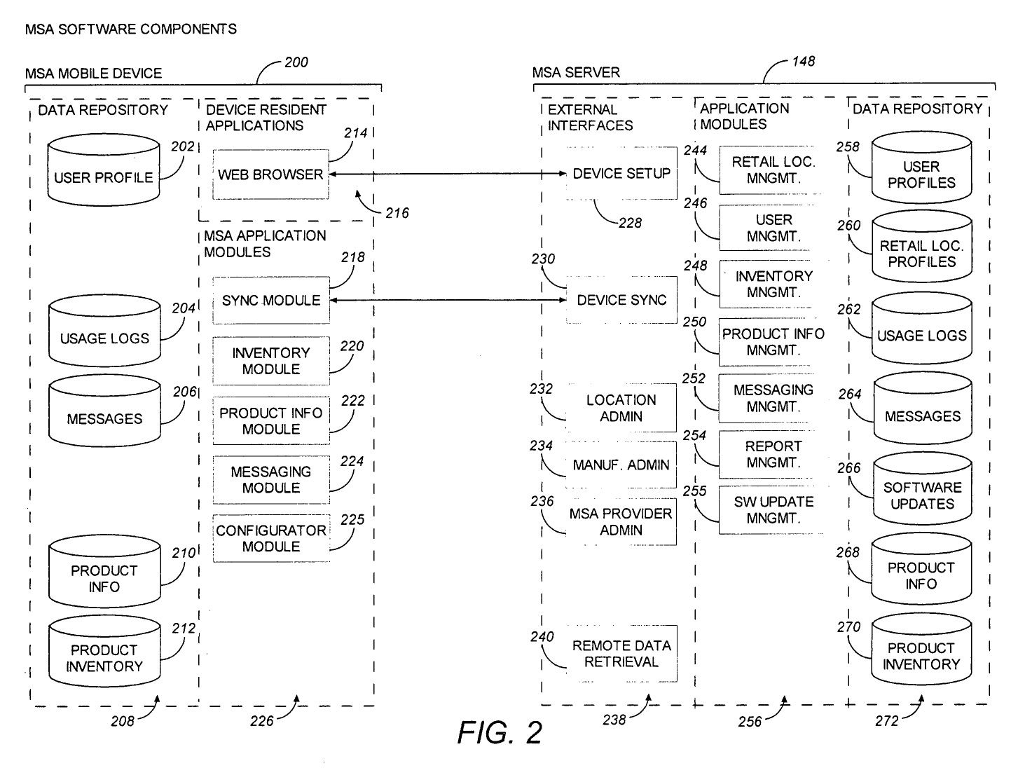

Referring now to FIG. 2, a block diagram of exemplary software components of a generic MSA mobile device 200 and the MSA server 148 will be described. The MSA mobile device 200 may be a PDA or cell phone, for example. The mobile device can include a user display, a way of user input, an operating system that supports persistent data storage and the installation and use of third party software applications, and a way of connecting to the Internet via a wired or wireless network interface. Example devices include the HP rx1950 and the Palm Treo 700w. A mobile device web browser 214 is used to access the MSA server device setup interface 228 (described later) in order to install the MSA software application and modules 226 on the mobile device. A sync module 218 accesses the MSA server device sync module 230 (described later) to retrieve application software and data updates. An inventory module 220 allows the mobile device user to manage inventory for a particular retail location. A product information module 222 allows the mobile device user to view product information such as features, specifications, comparisons, and other sales related data. A messaging module 224 allows the user to view messages, such as from a sales manager or from a manufacturer representative. A configurator module 225 allows the user to calculate the price of a product, such as a vehicle, by selecting from available options.

A mobile device data repository 208 can include the following components: a device user's profile 202, including permissions data specifying which functions the user has access to; a usage log database 204 that stores records of the functions performed by the user; a messages database 206 that stores the messages delivered to the mobile device user; a product information database 210 that stores product features, specifications, comparisons and other sales related data; and a product inventory database 212 that has records of the products currently and destined to be available for sale at a particular retail location.

The MSA server 148 includes a data repository 272, a set of application modules that provide various application functions 256, and a set of external interfaces 238 that package the application functionality for delivery to client devices, including mobile devices and PCs.

The MSA server data repository 272 includes a user profile database 258 that stores profiles for all users of the system. The user profile includes information such as the user's name, the type of user (salesperson, retail location administration (admin) user, manufacturer admin user, or MSA provider admin user), as well as various permissions describing the functionality available to the user. A retail location database 260 includes profiles of the retail locations where the MSA system is used. The retail location profile includes identifying information and may include information used for a remote data retrieval interface 240 (described later) to retrieve information from a server 110 at the retail location 102 (FIG. 1.) A usage log database 262 stores application usage data for all system users. A messages database 264 stores messages sent to users. A software updates database 266 stores application software updates for mobile devices. A product information database 268 stores product specifications, features, comparisons, and other sales related information. A product inventory database 270 contains all products that are currently or destined to be in inventory at the retail locations.

The set of MSA server application modules 256 divide the MSA server functionality into related functional areas. A retail location module 244 supports the management of retail locations; a user management module 246 supports the management of all system users; a inventory management module 248 supports the management of inventory; a product information management module 250 supports the management of product information; a messaging management module 252 supports the management of messages; a report management module 254 supports the management of reports generated from usage data; and a software update management module 255 supports the management of mobile device software updates.

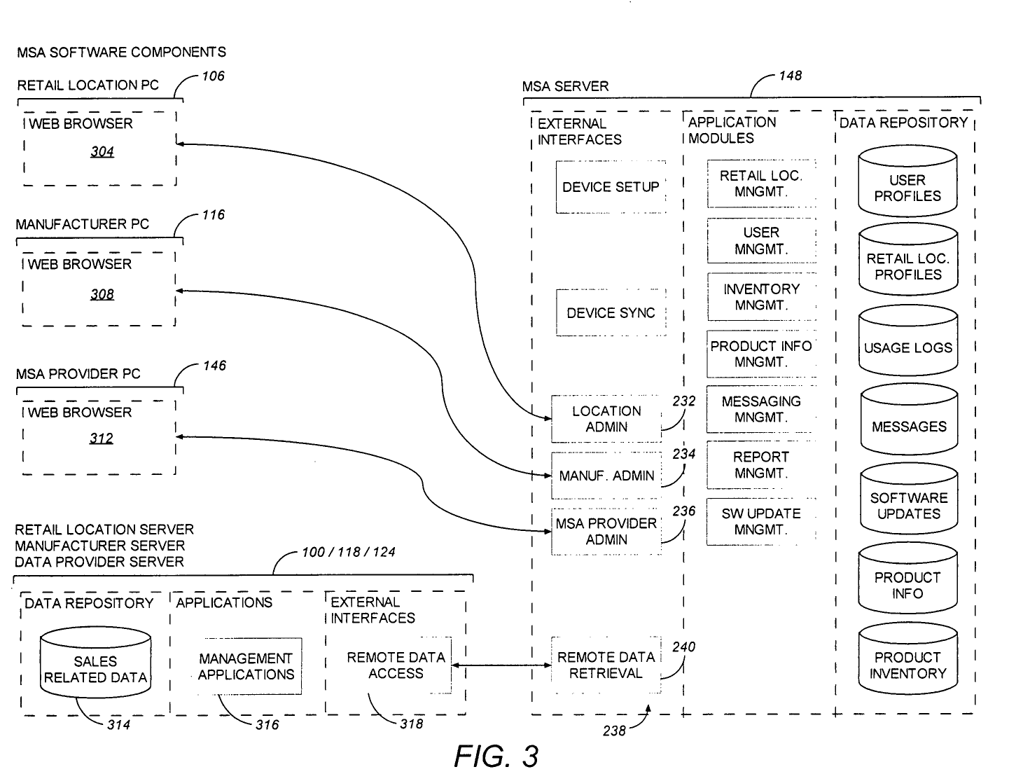

The set of MSA server external interfaces 238 combine various functions from the application modules 256 for delivery to client devices and their users. The external interfaces that support mobile devices will now be described. A device setup interface 228 allows new mobile devices to connect to the MSA server via the device's web browser and install the MSA mobile device application modules 226. A device sync module 230 handles application software and data update requests from the mobile device sync module 218. Referring now to FIG. 3, the remaining MSA server external interfaces 238 will now be described. A location admin interface 232 provides application functionality to a retail location administrator user with a PC 106 equipped with a web browser 304. The retail location administrator user may perform functions such as setting individual user permissions for salespeople employed at the retail location. A manufacturer admin interface 234 provides application functionality to a manufacturer administrator user with a PC 116 equipped with a web browser 308. The manufacturer admin user may perform functions such as viewing usage reports and updating product information. A MSA provider admin interface 236 provides application functionality to the MSA provider admin user with a PC 146 running a web browser 312. The MSA provider admin user may perform functions such as setting up new retail locations and users. A remote data retrieval interface 240 is responsible for retrieving data from remote servers, such as server 110, 118, and/or 124, that may be located at individual retail locations, manufacturers, or at third party data providers. The remote servers can include a data repository 314, such as for sales related data, applications used by the third party provider to manage the data 316, and a remote data access interface 318.

### II. Initial Configuration

The MSA system performs the following configuration tasks to be performed before the system can be used: 1) initial population of the software updates database 266, 2) initial population of the product information database 268, 3) creation of a retail location profile in the retail location profile database 260, 4) initial population of the product inventory database 270, and 5) creation of a user profile in the user profile database 258 (FIG. 2).

1. Initial Population of the Software Updates Database

In certain embodiments, this task is performed by a MSA provider admin user. The task involves registering the appropriate mobile device installation files in the MSA system using the MSA provider admin interface.

2. Initial Population of the Product Information Database

The product information database can be populated in at least two different ways: 1) it can be populated by an administrative user with the product information management module which will be described later; and 2) it can be populated by the remote data retrieval interface which retrieves product data from remote servers.

3. Creation of Location Profile

A location profile is created for every retail location where products are available for sale. Each location is associated with a set of users, a set of products, and a set of inventory. The process of creating a location profile will be discussed in the MSA Server Functionality section.

4. Initial Population of the Product Inventory Database

The product inventory database is populated by the MSA server remote data retrieval interface, which will be described in the MSA Server Functionality section.

5. Creation of User Profile

A user profile is created for every user that will use a mobile device. The process of creating a user profile will be discussed in the MSA Server Functionality section. Once a user profile has been created, the mobile device user can use the web browser on a mobile device to install the MSA mobile device application software.

### III. Mobile Device Functionality

The MSA mobile device application allows a salesperson user to easily access up-to-date product and inventory information using a simple and intuitive interface. It also automatically retrieves application and data updates from the MSA Server. This section will describe the following functions of the mobile device application: 1) application installation, 2) flow of execution, 3) user registration, 4) automatic updates, 5) user permissions, 6) a model picker user interface element, 7) a product information module, 8) an inventory module, 9) a messaging module, 10) a configurator module, 11) application usage logging, and 12) expandable text display.

1. Application Installation

The MSA mobile device application can be installed by using the web browser installed on the device. The web browser may be part of the device operating system, such as Microsoft Internet Explorer for Windows Mobile 5.0, or it may be a third-party web browser installed by the user. To install the MSA application in an exemplary embodiment, the mobile device user enters the address of the MSA server in the web browser, or may optionally click on an installation link embedded in an email message sent to the device by a MSA admin user. Once the installation page is accessed, the user enters login information including his email address and password. When valid login information is entered and submitted, the MSA mobile device application software is downloaded from the MSA server and installed on the device.

2. Flow of Execution

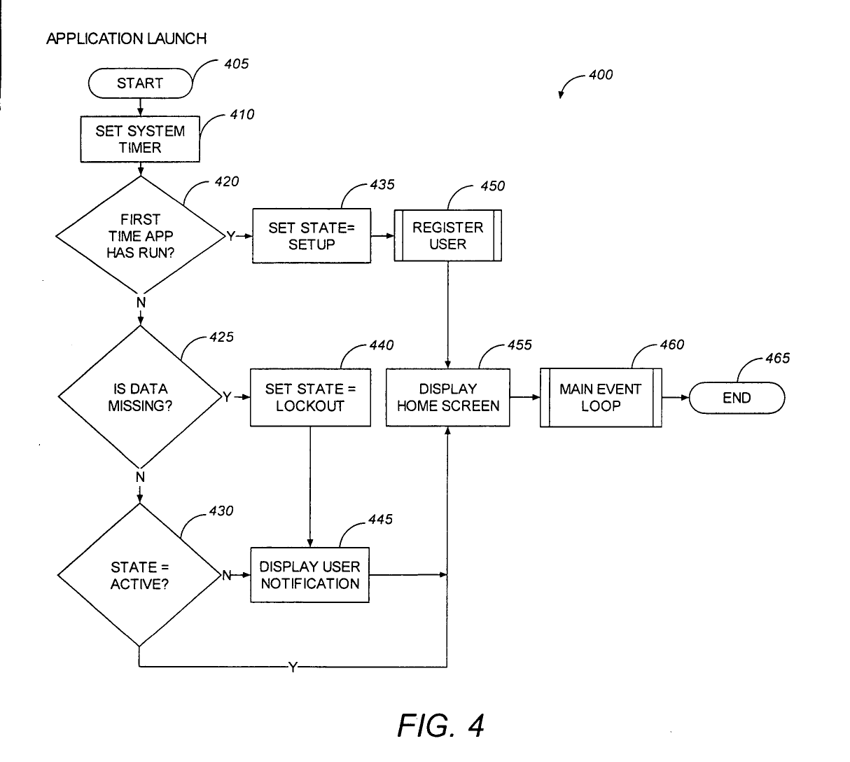

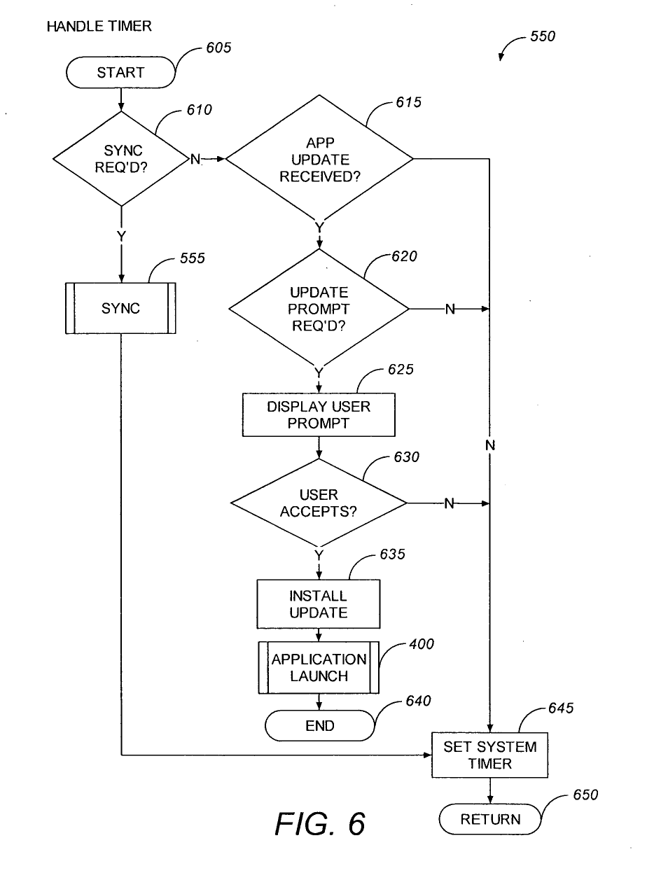

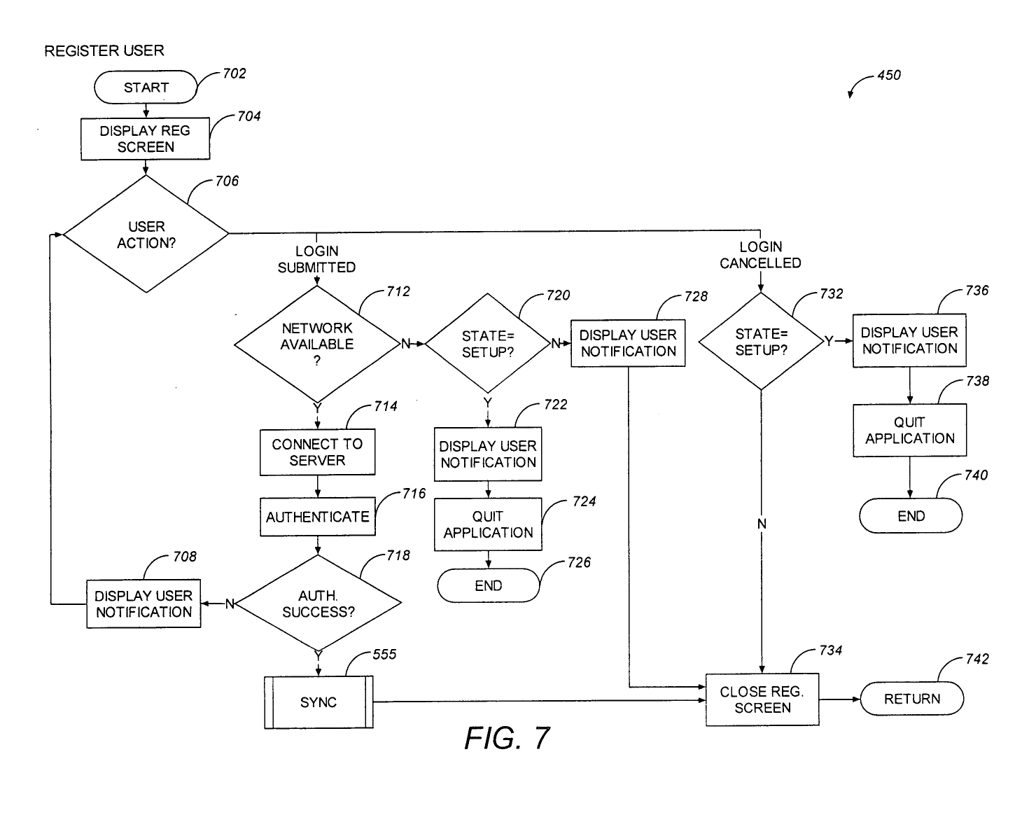

Referring to FIG. 4, an exemplary application launch process 400 for the mobile device application will now be described. Beginning at start state 405, the process moves to state 410 where a system timer is set to go off after one minute, in one embodiment. Other timer settings can be used in other embodiments. The timer mechanism allows the application to perform processing at regular time intervals. The processes performed when the timer goes off, or fires, will be described in conjunction with FIG. 6. Moving to decision state 420, process 400 determines whether the application has been launched for the first time. If so, process 400 advances to state 435 to set a global application state variable to setup. The global state variable determines whether the application is in the setup process, whether the user has access to the application, or whether the user is locked out for a reason such as: 1) the device has been unable to connect to the server for three consecutive days (or other time periods in other embodiments); 2) the user's access has been disabled by an administrative user, or 3) the user's login information has been entered on a different device, or 4) required files are missing. Process 400 proceeds to a user registration process 450, which will be described in conjunction with FIG. 7. Advancing to state 455, process 400 displays the application home screen.

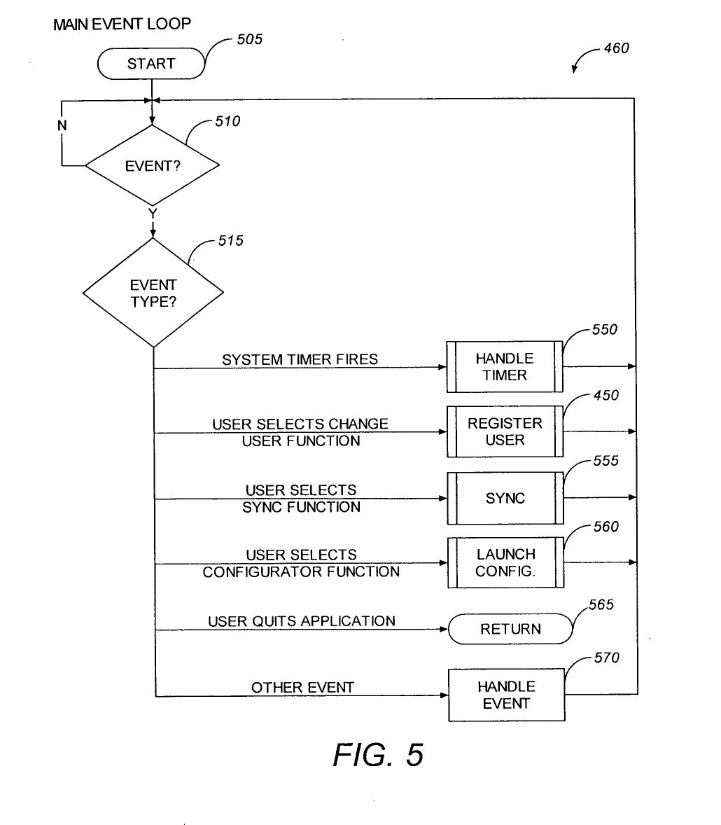

Returning to decision state 420, if the application has not been launched for the first time, process 400 continues to decision state 425 to determine if any files required by the MSA application are missing as the result of accidental deletion by the user. If files are missing, the application is set to lockout state at state 440. Proceeding to state 445, process 400 displays a user notification informing the user that the application will be disabled until the user connects to the MSA server. Returning to decision state 425, if the required files are not missing, process 400 advances to decision state 430 to determine whether the application state is active. If so, process 400 continues at state 455 and displays the home screen. If the application state is not active at decision state 430, process 400 displays a user notification at state 445 informing the user why the application is disabled and how to re-enable it. Advancing to state 455, process 400 displays the application home screen. After displaying the home screen, process 400 proceeds to state 460 and enters the main event loop process which will be described in conjunction with FIG. 5. The application launch process 400 ends at end state 465.

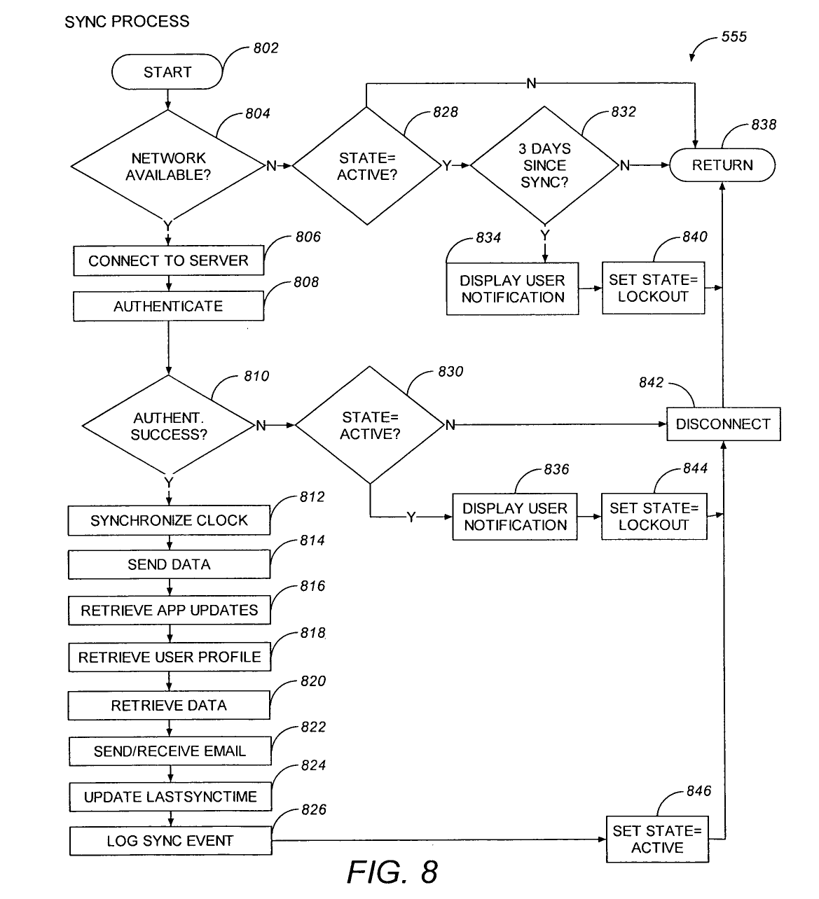

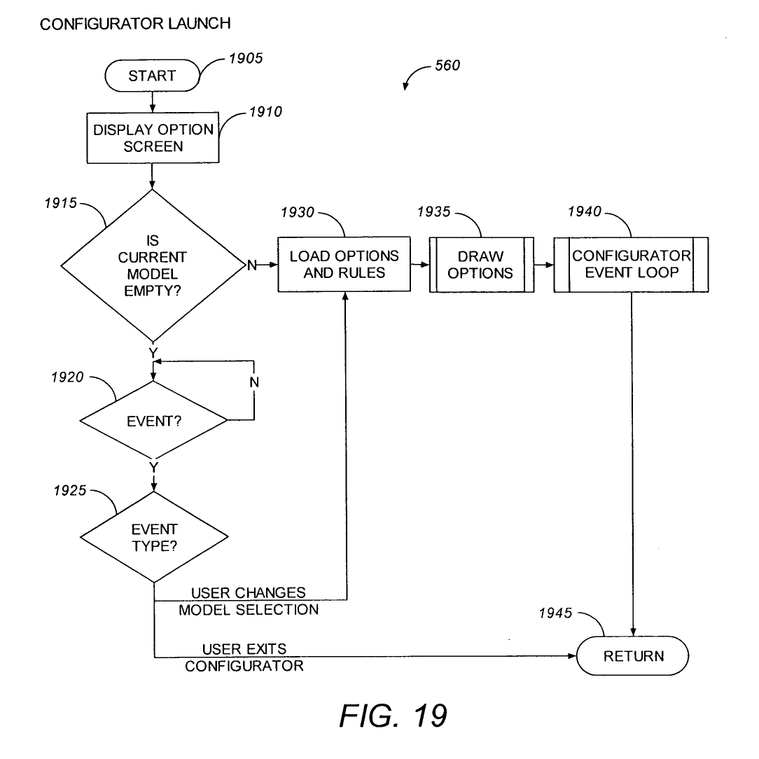

Referring to FIG. 5, the MSA mobile device application main event loop process 460 will now be described. Beginning at a start state 505, process 460 advances to a decision state 510 to determine whether an event has occurred. If not, process 460 returns to decision state 510. If an event does occur, process 460 advances to decision state 515 to determine the event type. If the event is the system timer firing, process 460 advances to a handle timer process 550 that will be described in conjunction with FIG. 6. If the event is user selection of the change user function, process 460 advances to a register user process 450 that will be described in conjunction with FIG. 7. If the event is user selection of the sync function, process 460 advances to a sync process 555 that will be described in conjunction with FIG. 8. If the event is user selection of the configurator function, process 460 advances to a configurator launch process 560 that will be described in conjunction with FIG. 19. If the event is the user quitting the application, process 460 advances to a return state 565 and returns to the application launch process 400. If the event is any other event, such as the user selecting a different function or the user entering data, for example, process 460 advances to state 570 where the event is handled.

Referring to FIG. 6, the handle timer process 550 will now be described. Beginning at a start state 605, process 550 advances to decision state 610 to determine whether a sync (connection to the MSA server) is required. In an exemplary embodiment, this determination is made based on the amount of time that has passed since the previous sync. In other embodiments other factors may also be considered, such as whether the user has modified data or entered new data. If a sync is required, process 550 advances to the sync process 555, which will be described in conjunction with FIG. 8.

Referring back to decision state 610, if a sync is not required, process 550 proceeds to decision state 615 to determine whether an MSA application update has been received during a prior sync. If an update has been received, process 550 advances to state 620 to determine whether an update prompt should be displayed to the user. In an exemplary embodiment, this determination is based on the amount of time since the last user action in order to avoid interrupting the user. If an update prompt is required, process 550 advances to state 625 to display the prompt, which requests the user to accept or defer the update. Advancing to decision state 630, process 550 determines whether the user accepts the update. If so, process 550 advances to 635 and installs the update. Process 550 then advances to application process 400 already described. Process 550 ends at end state 640.

Process 550 reaches state 645 from one of four states: at the completion of sync process 555, decision state 615 if an update has not been received, decision state 620 when the update prompt is not required, or decision state 630 when the user defers the update. At state 645, process 550 sets a system timer for one minute, and then advances to return state 650 and returns back to the main event loop process 460.

3. User Registration

Referring to FIG. 7, the register user process 450 will now be described. Beginning at a start state 702, process 450 advances to state 704 and displays a registration screen. Proceeding to decision state 706, process 450 waits for one of two user actions: the user submits login information, or the user cancels the registration process. If the user submits login information, process 450 advances to decision state 712 and determines whether a network connection is available. If a connection is available, process 450 continues to state 714 and initiates a connection with the MSA server. Advancing to state 716, process 450 authenticates the login information submitted by the user against the user profiles stored on the MSA server. Proceeding to decision state 718, process 450 determines whether authentication was successful. If authentication is successful, process 450 advances to the sync process 555 that will be described in conjunction with FIG. 8. If authentication is not successful, process 450 advances to state 708 and displays an error message to the user. Process 450 then returns back to state 706 to wait for a subsequent user action.

Referring back to decision state 712, if a network connection is not available, process 450 proceeds to decision state 720 to determine whether the application is in the setup state. If so, process 450 advances to state 722 and displays a user notification informing the user that a network connection is required for setup. Process 450 advances to state 724 where the application quits. Process 450 ends at end state 726. Referring back to state 720, if the application is not in the setup state, process 450 proceeds to state 728 and displays a user notification informing the user that a network connection is required.

Referring back to decision state 706, if the user cancels the login screen, process 450 advances to decision state 732 to determine whether the application is in the setup state. If so, process 450 advances to state 736 and displays a user notification informing the user the login process is required to use the application. Process 450 advances to state 738 where the application quits. Process 450 ends at state 740.

Process 450 reaches state 734 from one of three states: at the completion of sync process 555, state 728, or decision state 732 when the application is not in the setup state. At state 734, process 450 closes the registration screen. At return state 742, process 450 returns to the process from which it was executed: application launch process 400 or main event loop process 460.

4. Automatic Updates

Referring now to FIG. 8, the sync process 555 will now be described. Beginning at a start state 802, process 555 advances to decision state 804 and determines whether a network connection is available. If a connection is available, process 555 continues to state 806 and initiates a connection with the MSA server. Advancing to state 808, process 555 authenticates the login information submitted by the user against the user profile database on the MSA server. Proceeding to decision state 810, process 555 determines whether the authentication was successful. If authentication is successful, process 555 advances to state 812 and synchronizes the internal clock on the mobile device with the time on the MSA server based on the time zone stored in the location profile associated with the user's user profile on the MSA server. Proceeding to state 814, process 555 sends data to the MSA server including usage log data and other data entered by the user. Advancing to state 816, process 555 checks for application updates and downloads them if available. Continuing at state 818, process 555 retrieves the user profile and the location profile from the MSA server and stores them in user profile database 202 (FIG. 2). Process 555 proceeds to state 820 and retrieves data updates for all data associated with the user's location profile, including product information, inventory information, messages, and other sales related data, and then stores it in the data repository 208 (FIG. 2). The size of the data updates depends on the amount of data that has changed since the last sync process was successfully completed. For example, if the device had never completed the sync process before, the data update would be at its maximum size. However, if the sync process had completed one hour before, the updates would include only data that had been added or modified in the prior hour. Advancing to state 822, process 555 initiates an email send/receive function of an email application (not shown) on the device. Process 555 proceeds to state 824 to store the time the sync process was completed. Advancing to state 826, process 555 creates a log entry in the usage log 204 (FIG. 2) to record successful completion of the sync process. Continuing to state 846, process 555 sets the application state to active. Process 555 proceeds to state 842 and disconnects from the MSA server. Process 555 returns to the parent process at return state 838.

Referring back to decision state 804, if a network connection is not available, process 555 advances to a decision state 828 to determine whether the application state is active. If the state is not active, process 555 advances to return state 838 and returns to the parent process. If the application state is active at decision state 828, process 555 advances to decision state 832 to determine whether three days have passed since the last successful sync. If three days have passed, process 555 proceeds to state 834 to notify the user that the MSA application will be disabled until a successful sync can be completed. Process 555 then advances to state 840 to set the application to the lockout state. Process 555 then returns to the parent process at return state 838. Returning to decision state 832, if three days have not passed, process 555 returns to the parent process at return state 838.

Referring back to decision state 810, if process 555 determines that authentication is unsuccessful as the result of conditions such as: 1) the login information is invalid; 2) the login information is in use on another device; or 3) the user's access has been disabled by an administrative user, then process 555 advances to decision state 830 and determines whether the application state is active. If the state is active, process 555 advances to state 836 and displays a user notification explaining the type of authentication failure and instructions for resolving it. Process 555 then proceeds to state 844 and sets the application state to lockout. Process 555 proceeds to state 842 and disconnects from the MSA server. Process 555 returns to the parent process at return state 838. Returning to decision state 830, if the state is not active, process 555 proceeds to state 842 and disconnects from the MSA server. Advancing to return state 838, process 555 returns to the parent process.

5. User Permissions

Various modules and functions within the MSA application may be enabled or disabled for a particular user. User permissions may be granted by various administrative users, as will be described in the MSA Server Functionality section. If a module or function is disabled, the MSA application may not display the module or function to the user, or it may display a user notification message when the user access a function that is disabled. For example, in an embodiment where the MSA provider offers individual modules for sale to retailers, the MSA application would only display the modules purchased.

User permission data is stored in the user profile database on the device and is accessed directly by the MSA application. User permissions may be changed at any time by an administrative user. After such change, the updated permission information contained in the user profile will be retrieved during the sync process 555 (FIG. 8), enabling the updated permissions to be reflected in the MSA application once the sync process completes.

6. Model Picker User Interface Element

The following description assumes an exemplary embodiment where the products are automobiles.

The model picker user interface element is used throughout the MSA application on screens that have the user to select a model in order to perform a function. The model picker displays the currently selected model, and allows the user to change the selection. Various screens (and functions) within the application use model selections with varying levels of detail. For example, in an exemplary embodiment, a screen that allows a user to read vehicle reviews has the user select a model based on a combination of model year and name. However, a screen that provides specifications has the user select a model based on a combination of model year, name and trim. This is because reviews generally apply to all trims for a given model year, whereas specifications are different for each trim within a model year. In addition to selections varying by amount of detail required, the set of available model selections may also vary between functions based on criteria such as whether a model is new or used, or whether vehicles of a given model are in inventory. For example, an inventory screen only allows selection of models that are actually in inventory.

From a user perspective, the model picker comprises a display area that displays the currently selected model, and a hierarchical pop-up menu that appears when the user performs an action to change the selection. In an exemplary embodiment, the user taps the model picker display area with a stylus to change the selection. In another embodiment, the user may press a series of buttons. When the hierarchical menu appears, the model picker organizes and displays the appropriate set of selections, based on the function available on the current screen. When the user makes a selection, the selection is stored until a subsequent screen containing the model picker is displayed. At the time the subsequent screen is drawn, it is possible that the previously displayed selection may not be consistent with the available selections on the subsequent screen. If the previous selection is not consistent, it may be cleared, requiring the user to make a new selection. For example, assume two different screens within an exemplary MSA application embodiment: a specifications screen that provides specifications for all new and used models, and a comparisons screen that provides comparisons for new models only. If the user first selects a new model from the model picker on the specifications screen, and then accesses the comparisons screen, the model selection will be retained because both screens allow for the selection of new models. In this case, the model picker saves the user from re-selecting the model. However, if the user first selects a used model on the specifications screen and then accesses the comparisons screen, the original selection will be cleared, because the comparison screen does not provide comparisons for used models. In this case, the user will need to make a new selection with the model picker.

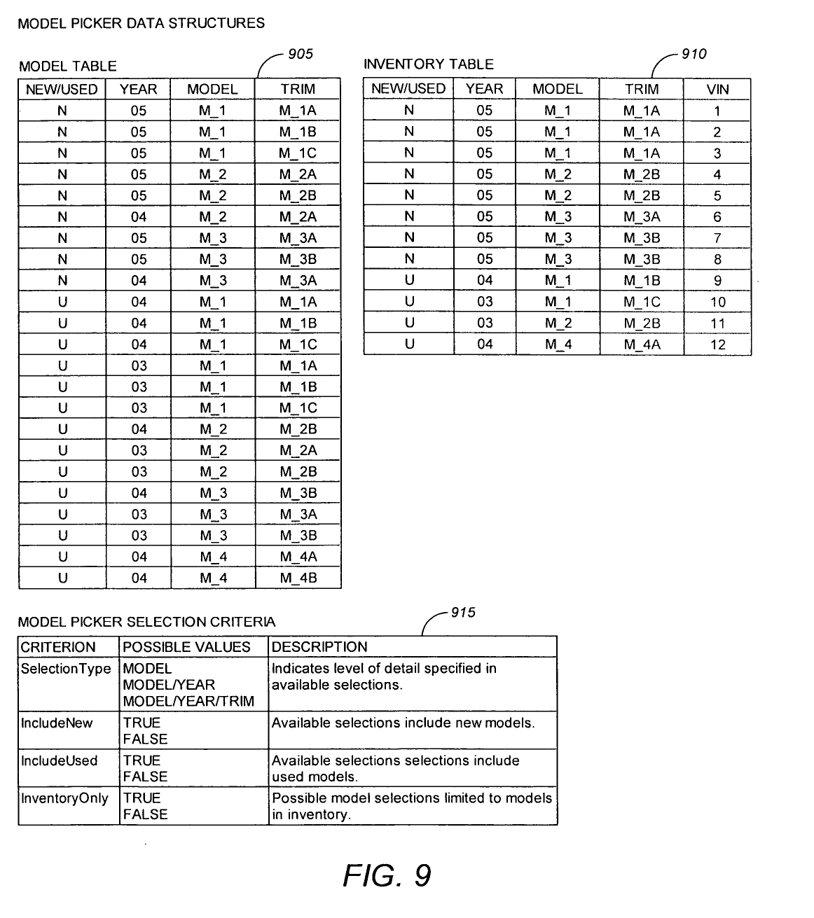

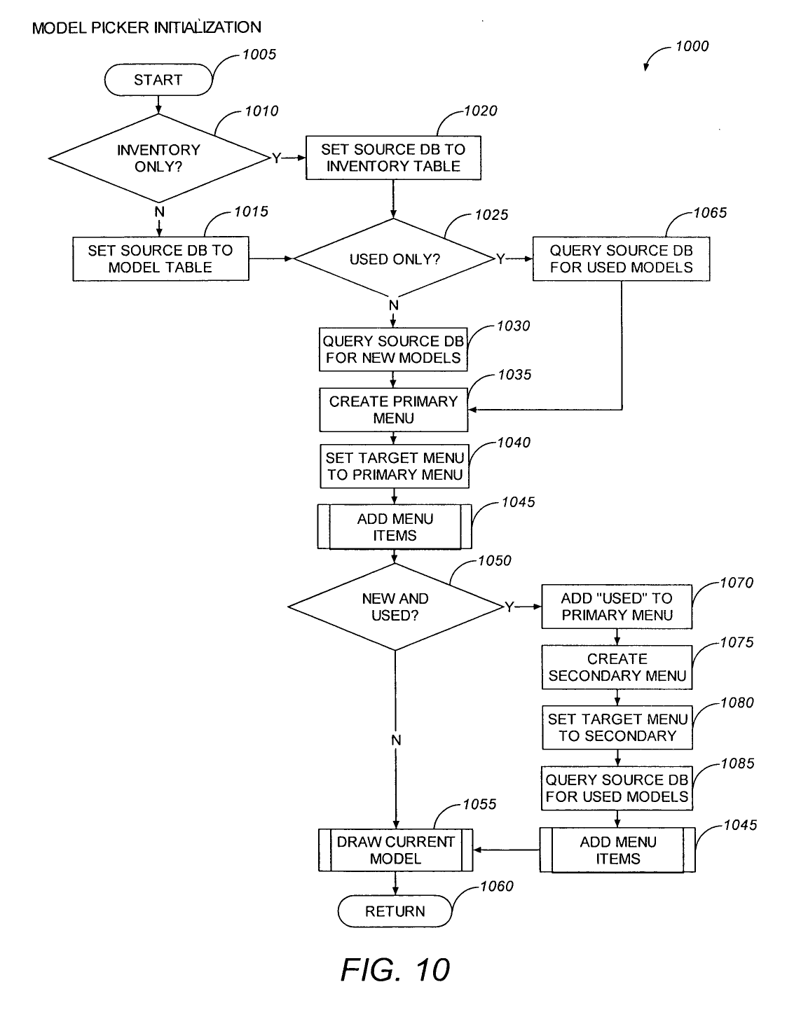

Referring to FIG. 9, the data structures used by the model picker will now be described. A model table 905 stores all vehicle models. In certain embodiments, an inventory table 910 stores all vehicles in inventory at the retail location associated with the user profile. Note that table 910 includes columns not shown describing additional vehicle attributes. The model table 905 and the inventory table 910 are stored in the vehicle information database 210 and in the vehicle inventory database 212, respectively (FIG. 2). Table 915 shows the set of criteria that define the structure of an instance of the model picker on a given screen. These criteria are defined programmatically within MSA mobile device application itself and are used in the model picker initialization process that will be described in conjunction with FIG. 10.

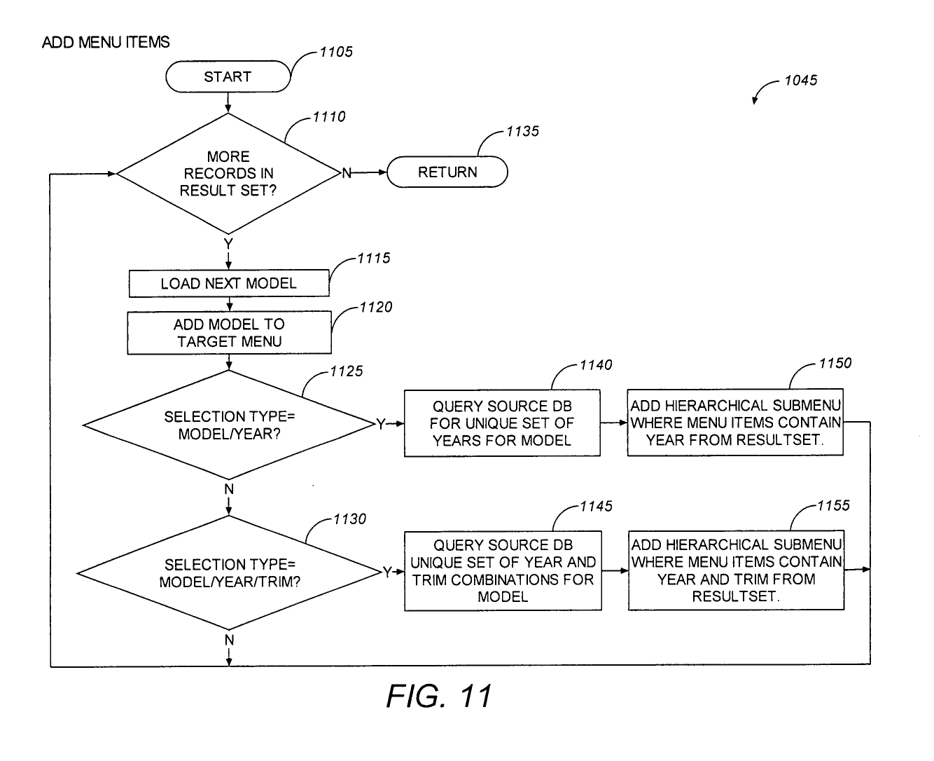

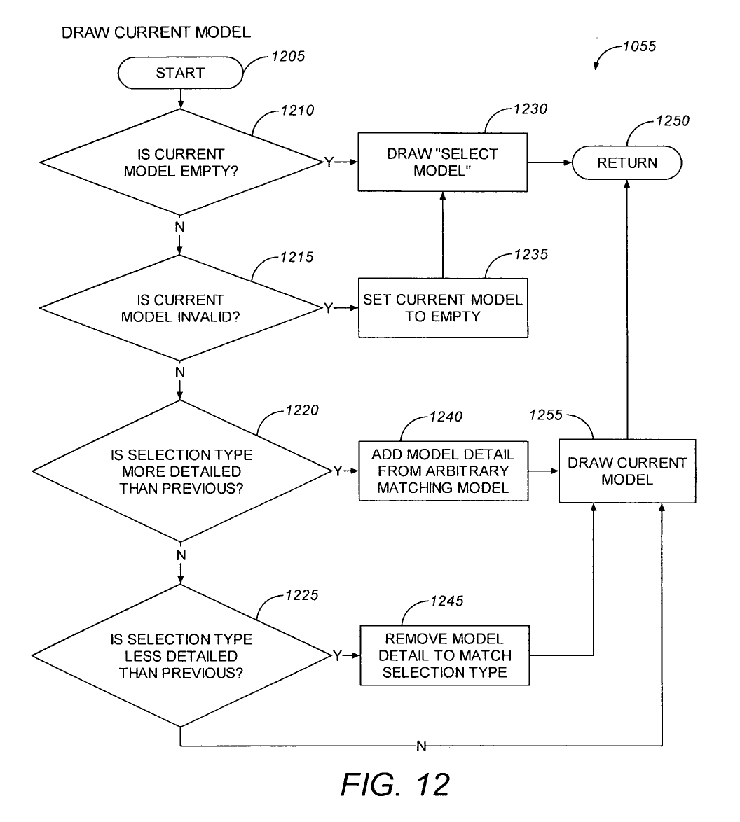

Referring to FIG. 10, a model picker initialization process will now be described. In an exemplary embodiment, this process begins when a screen utilizing the model picker is displayed by the MSA mobile device application (not shown). Beginning at a start state 1005, process 1000 proceeds to a decision state 1010 to determine whether the selection criteria limits available selections to vehicles in inventory. If so, process 1000 advances to state 1020 to set the source database to the inventory table. If not, process 1000 advances to state 1015 to set the source database to the model table. Continuing at decision state 1025, process 1000 determines whether the selection criteria limit available selections to used vehicles only. If so, process 1000 advances to state 1065 and queries the source database for used models. If the selection criteria do not limit selections to used vehicles only, process 1000 advances to state 1030 to query the source database for new models. Continuing at state 1035, process 1000 creates the primary menu. Proceeding to state 1040, process 1000 sets the target menu to the primary menu just created. The primary menu displays used models if the selection criteria are limited to used models only; otherwise it displays new models. Process 1000 continues at an add menu items process 1045 that will be described in conjunction with FIG. 11. Advancing to decision state 1050, process 1000 determines whether the selection criteria include both new and used models. If not, process 1000 advances to a draw current model process 1055 that will be described in conjunction with FIG. 12. If the selection criteria do include new and used vehicles, process 1000 advances to state 1070 and adds a menu item with the word “used” at the bottom of the primary menu. Proceeding to state 1075, process 1000 creates the secondary menu to display used models. Advancing to state 1080, process 1000 sets the target menu to the secondary menu. Continuing at state 1085, process 1000 queries the source database for used models. Process 1000 next advances to the add menu items process 1045 that will be described in conjunction with FIG. 11, and subsequently to the draw current model process that will be described in conjunction with FIG. 12. Process 1000 returns to a host application process (not shown) at return state 1060.

Referring to FIG. 11, an add menu items process 1045 will now be described. This process is used to add the menu items and associated hierarchical sub-menus to the primary and secondary menus. Beginning at a start state 1105, process 1045 advances to state 1110 to determine whether there are unprocessed records in the result set. If not, process 1045 returns to a parent process shown in FIG. 10. If unprocessed records do exist, process 1045 advances to state 1115 to load the next model for processing. Advancing to state 1120, process 1045 adds the model name to the target menu. Proceeding to decision state 1125, process 1045 determines whether the selection type is model and year. If so, process 1045 advances to state 1140 to query the source database for records for the unique set of years associated with the model being processed. Continuing at state 1150, process 1045 creates a hierarchical submenu at the model name added in state 1120 with menu items representing each the years queried at state 1140. Process 1045 returns to decision state 1110 to continue processing models.

Referring back to decision state 1125, if the selection type is not model and year, process 1045 advances to decision state 1130 to determine whether the selection type is model and year and trim. If not, process 1045 returns to decision state 1110 to continue processing the set models. If the selection type is model and year and trim, process 1045 advances to state 1145 to query the source database for the unique set of year and trim combinations associated with the model being processed. Advancing to state 1155, process 1045 creates a hierarchical submenu at the model name added in state 1120 with menu items representing each of the year and trim combinations queried at state 1145. Process 1045 returns to decision state 1110 to continue processing models.

Referring to FIG. 12, a draw current model process 1055 will now be described. Beginning at a start state 1205, process 1055 advances to state 1210 to determine whether the current model is empty (a model has not been selected before). If so, process 1055 continues at state 1230 and draws the text “select model” indicating to the user that a new selection can be made. Process 1055 returns at return state 1250 to state 1060 (FIG. 10). Referring back to decision state 1210 when the current model is not empty, process 1055 advances to state 1215 to determine whether the current model is invalid as the result of inconsistent selection criteria. For example, the current selection would be invalid if it the current model was a used model and the selection criteria no longer included used models. If the model is invalid, process 1055 advances to state 1235 to set the current model to empty, and then advances to state 1230 described above. If the model is not invalid, process 1055 advances to state 1220 to determine whether the new selection type is more detailed than the previous selection type. If so, process 1055 advances to state 1240 to add detail to the currently selected model using details from an arbitrary record in the model table that matches the currently selected model. For example, assume that at decision state 1220 the previous selection type is model only and that the new selection type is model and year. Referring briefly to model table 905 in FIG. 9, if the previous current model was “M_{—}1” at decision state 1220, process 1055 would change it to “05 M_{—}1” at state 1240. Note that although “05” was added, “04” and “03” could also have alternatively been added because they are included in records that contain model “M_{—}1”.

Referring back to decision state 1220, if the current selection type is not more detailed than the previous selection type, process 1055 advances to decision state 1225 to determine whether the new selection type is less specific than the previous selection type. If so, process 1055 advances to state 1245 where the model detail is removed from the current selection to be consistent with the new selection type. For example, assume that at decision state 1225 the previous selection type is model and year and trim, and that the new selection type is model only. Continuing with the example, if the current model was “05 M_{—}1 M_{—}1A” at decision state 1225 and the new selection type was model only, process 1055 would remove the year and trim components at state 1245, changing the current model to “M_{—}1”.

Process 1055 reaches state 1255 from one of three states: state 1225, state 1245, or decision state 1240 when the current selection type is less specific than the previous. At state 1255, process 1055 draws the current model on the model picker. Process 1055 returns at return state 1250 to state 1060 (FIG. 10).

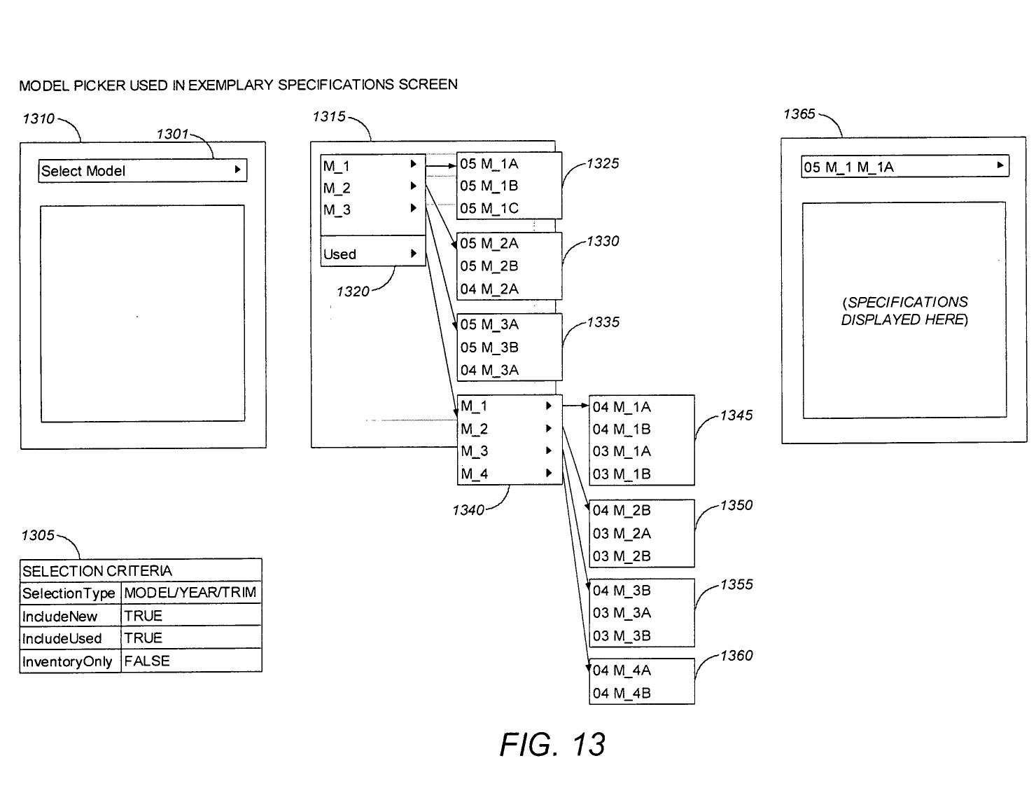

Referring now to FIG. 13, an example usage scenario of the model picker will be described. Table 1305 illustrates the selection criteria as used by the model picker in an exemplary screen used to view model specifications In this case, the selection criteria will allow the user to select model, year, and trim, from all available new and used models in the model database. Mobile device screen 1310 illustrates the model picker once model picker initialization process 1000 (FIG. 10) completes for the first time. Mobile device screen 1315 illustrates the complete hierarchical menu structure of the model picker using model data from the model table 905 (FIG. 9). In certain embodiments, only one menu from the column of menus starting with menu 1325 can be visible at one time, as is the case with the column starting with menu 1345. Menu 1320 represents the primary menu and menu 1340 represents the secondary menu. Menus 1325, 1330, and 1335 represent the unique year and trim combinations for each of the models in primary menu 1320, and menus 1345, 1350, 1355, and 1360 represent the unique year and trim combinations for the each of the models in secondary menu 1340. Mobile device screen 1365 illustrates the model picker 1301 after the first model in menu 1325 is selected by the user.

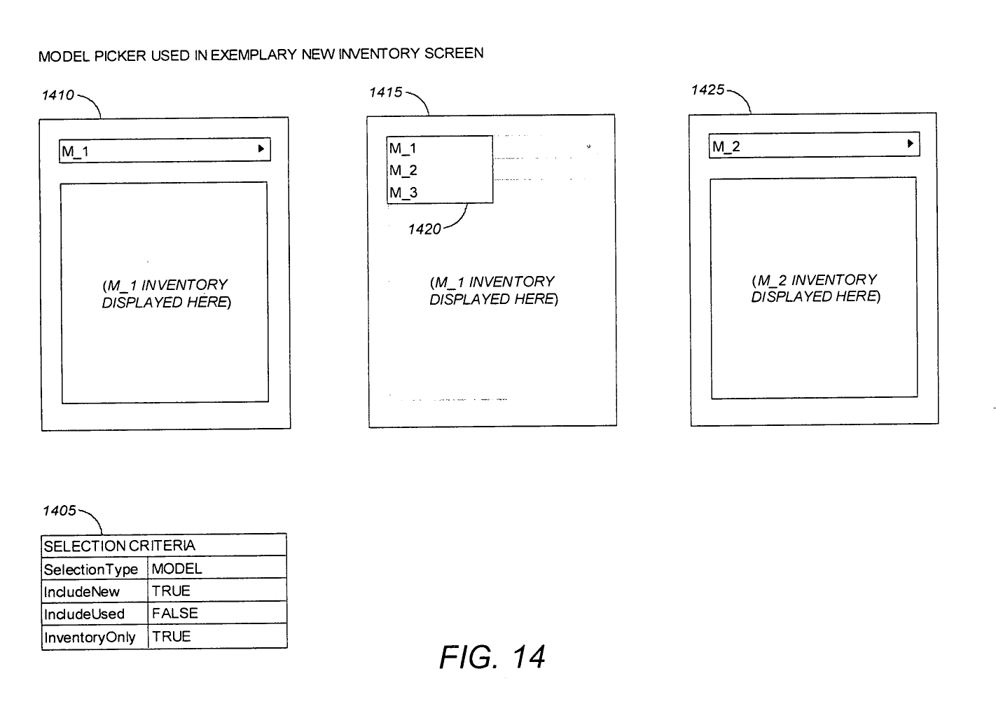

Referring now to FIG. 14, the description of the example scenario will continue. Table 1405 illustrates the selection criteria as used by the model picker for an exemplary new inventory screen. In this case, the selection criteria will allow the user to select a model from a list of new models in inventory. Mobile device screen 1410 illustrates the model picker once initialization process 1000 (FIG. 10) completes. Note that detail has been removed from the model selection shown on mobile device screen 1365 (FIG. 13) to reflect the selection type in table 1405. Mobile device screen 1415 illustrates the complete hierarchical menu structure of the model picker using data from the inventory table 910 (FIG. 9). Mobile device screen 1425 illustrates the model picker after the second menu item in menu 1420 is selected by the user.

7. Product Information Module

The product information module provides functions that allow the user to view various types of product information. Product information can include specifications, features, benefits, available options, comparisons, reviews, and other product related data. For example, a specifications function allows the user to select a model, and then displays the associated specifications. Similarly, a comparison function allows the user to select a model, and then allows the user to select from a list of available competitors. Once a competitor is chosen, a comparison between the two products is displayed. The comparison may be viewed in several ways including: 1) a side-by-side view showing attributes of both products, 2) an advantage view summarizing the advantages of one product compared to other, or 3) a disadvantage view summarizing the disadvantages of one product compared to the other.

8. Inventory Module

The inventory module provides functions that allow the user to view and search for individual products in current inventory or scheduled to be in inventory, as well as enter data associated with products in inventory. In an embodiment where the products are automobiles, the inventory module allows the user to search from all vehicles available for sale at a particular dealership, and/or vehicles in transit to the dealership. In the same embodiment, the user may enter data such as the location where the vehicle is parked, and notes that may include whether a vehicle has damage and requires repairs. All data entered by the user is stored in the product inventory database, sent to the MSA server during the sync process, and retrieved by other mobile devices during the sync process.

9. Messaging Module

The messaging module allows users to receive and read broadcast messages sent by administrative users. When the user reads a message, the current time is stored on the device and is sent back to the MSA server in order for the sender to monitor receipt of the message.

10. Configurator Module

The following description of the configurator module assumes an exemplary embodiment where products in the MSA system are automobiles. Many automobile manufacturers offer a variety of options on the vehicles they produce. However, the available options can only be combined in certain ways. For example, “Option A includes Option B,” or “Option C cannot be ordered with Option D.” The configurator defines a mechanism for describing these relationships as well as a mechanism for enforcing them as the user selects options and configures a vehicle. This allows a user to quickly and correctly specify a vehicle with desired options and calculate total price.

In one embodiment, the configurator recognizes and enforces four different types of rules, or relationships, between options. Note that embodiments of the invention anticipate the addition of other types of rules not listed.

a. Option A requires Option B.
This means Option A cannot be selected until option B has been selected. This rule may also be stated as “Option A must be ordered with Option B”.

b. Option A requires one of multiple options (Option B, Option C, Option D).
This means that Option A can only be selected if one or more of the options in the set are also selected. This rule may also be stated as “Option A must be ordered with Option B, Option C, or Option D.”

c. Option A includes Option B.
This means that when option A is selected, option B will also be selected. Additionally, although Option A and Option B each have individual prices, Option A and Option B will be collectively priced at Option A's price.

d. Option A excludes Option B.
This means that if option A is selected, option B cannot be selected. This rule may also be stated as “Option A cannot be ordered with Option B” or “Option A not available with Option B.”

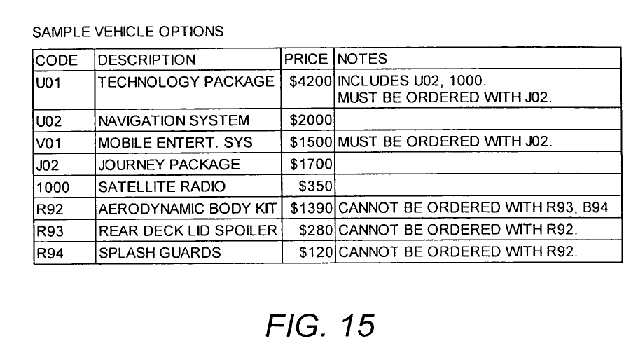

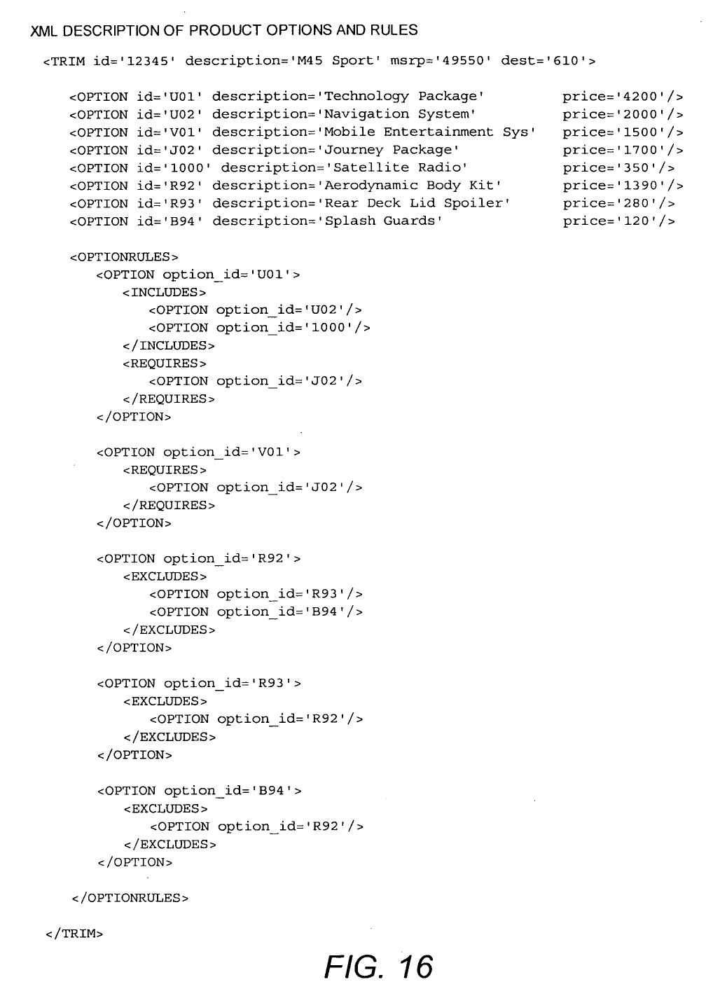

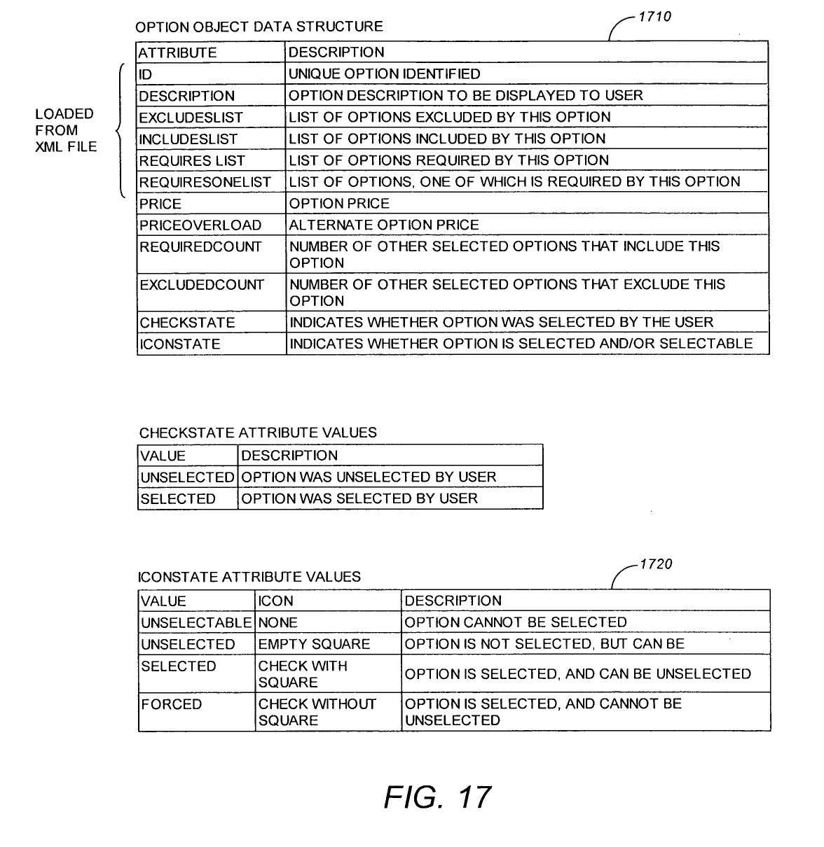

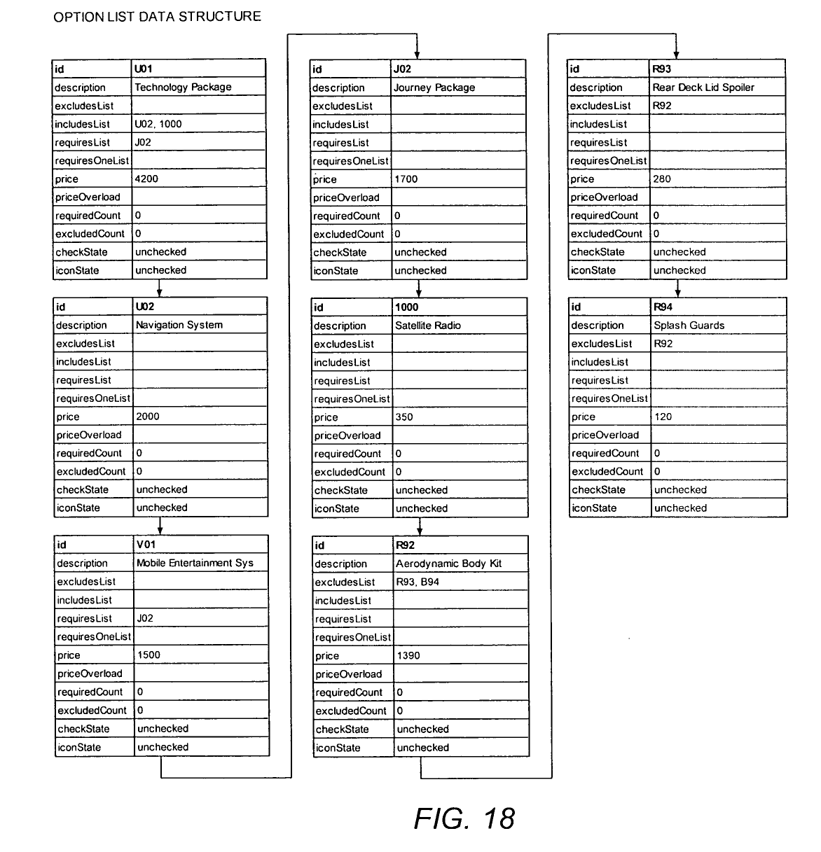

In order for the configurator to process and enforce the rules, they are converted to an electronic format and delivered to the mobile device. FIG. 15 shows a list of options and rules for a sample vehicle as they might appear on a pricing sheet from the manufacturer. In one embodiment, an analyst or programmer transforms the options and rules into a XML file as shown in FIG. 16, which is then stored on the MSA server and subsequently retrieved by the MSA mobile device application during the sync process 555 (FIG. 8). In an exemplary embodiment, once on the device, the XML data is loaded by the configurator into a linked list of option objects that can be manipulated in memory. In other embodiments, other data structures such as arrays could be used. FIG. 17 illustrates an exemplary option object and its attributes. FIG. 18 illustrates the complete object option lists after the configurator loads the XML data shown in FIG. 16.

In one embodiment, the configurator user interface consists of two screens: 1) and options screen that allows the user to select a model and associated options; and 2) a summary screen that shows a summary of all options selected including total price. When initially launched the configurator displays the options screen, and the user may switch between the options and summary screens at any time.

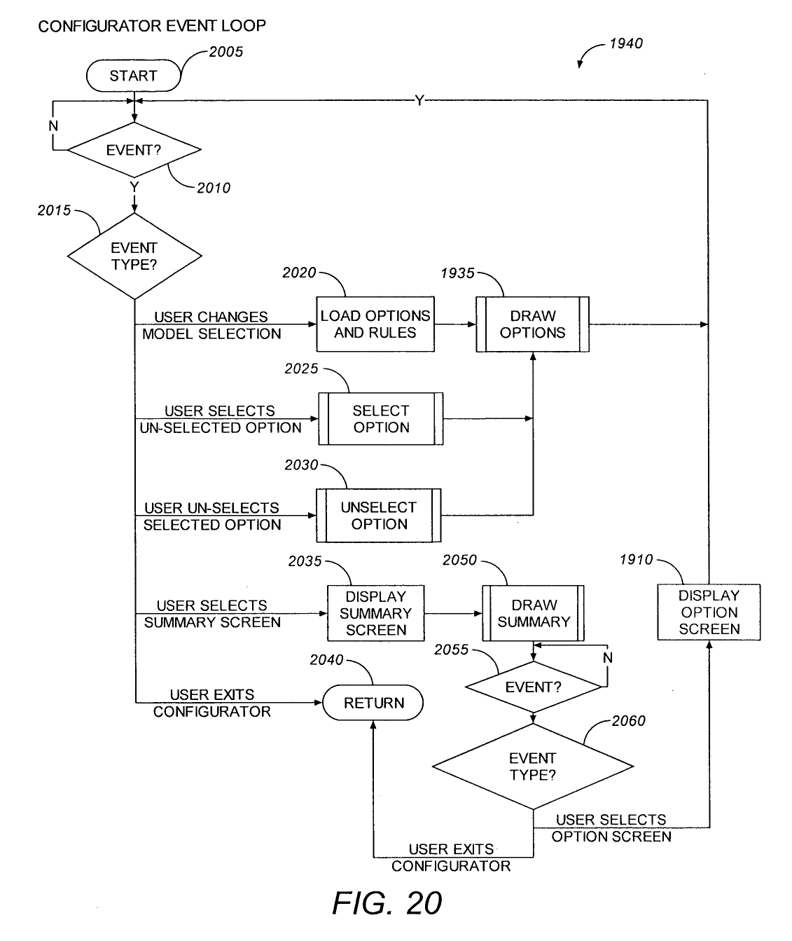

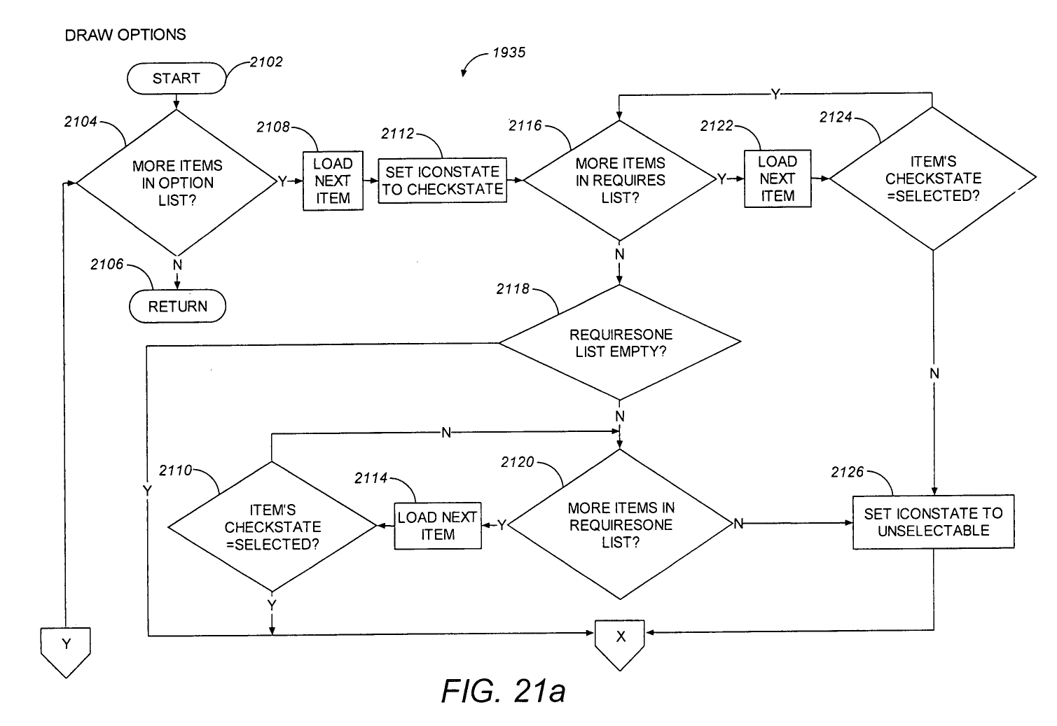

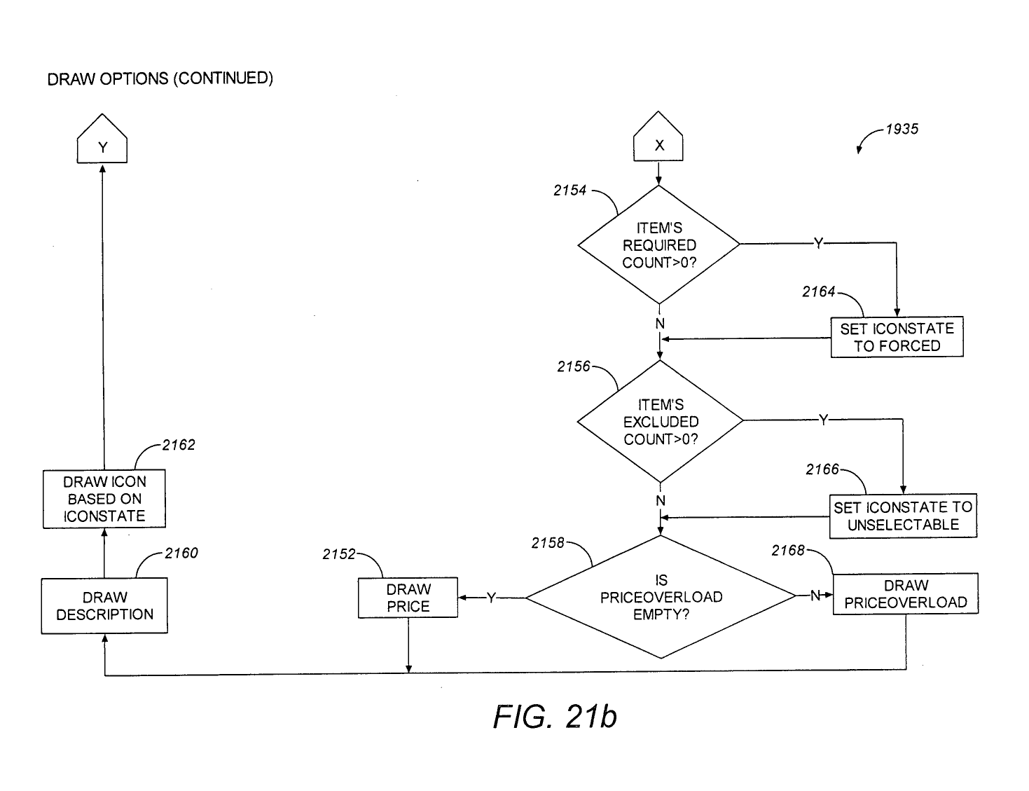

Referring now to FIG. 19 a configurator launch process 560 will now be described. Beginning at a start state 1905, process 560 advances to state 1910 to display the options screen. Because the options screen includes an instance of the model picker user interface element, the model picker initialization process 1000 (FIG. 10) occurs within state 1910, although not shown. Proceeding to a decision state 1915, process 560 determines whether the current model selection is empty. If not, process 560 advances to state 1930 to load option data for the currently selected model from the XML file into memory. Process 560 advances to a draw options process 1935 that will be described in conjunction with FIGS. 21a and 21b. Process 560 continues at a configurator event loop process 1940 that will be described in conjunction with FIG. 20. Proceeding to return state 1945, process 560 returns to decision state 510 of the main even loop process (FIG. 5).

Referring back to decision state 1915, if the current model is empty, process 560 advances to decision state 1920 to wait for an event. When an event does occur, process 560 advances to decision state 1925 to determine the event type. If the event is the user changing the model using the model picker, process 560 advances to state 1930 as described above. If the event is the user exiting the configurator, process 560 returns to decision state 510 of the main event loop (FIG. 5).

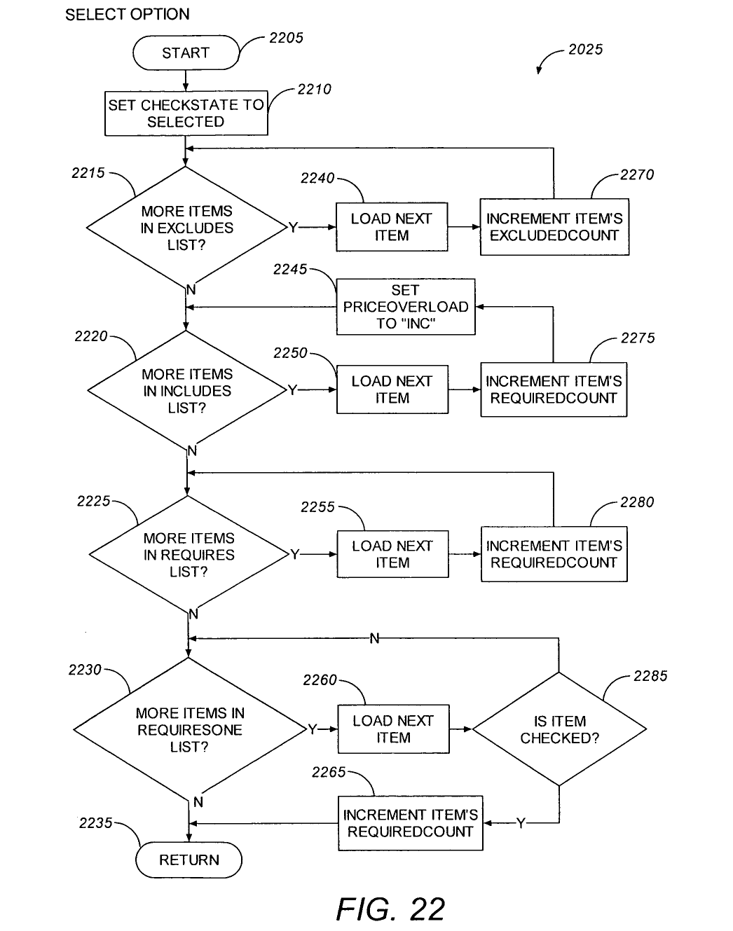

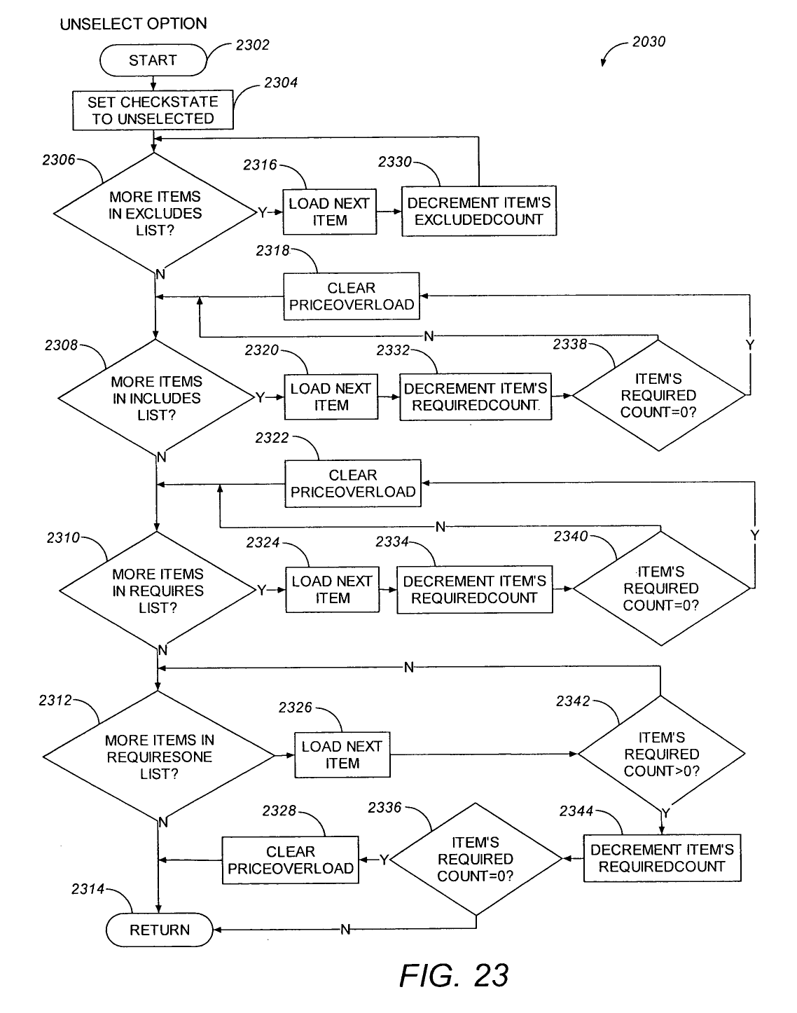

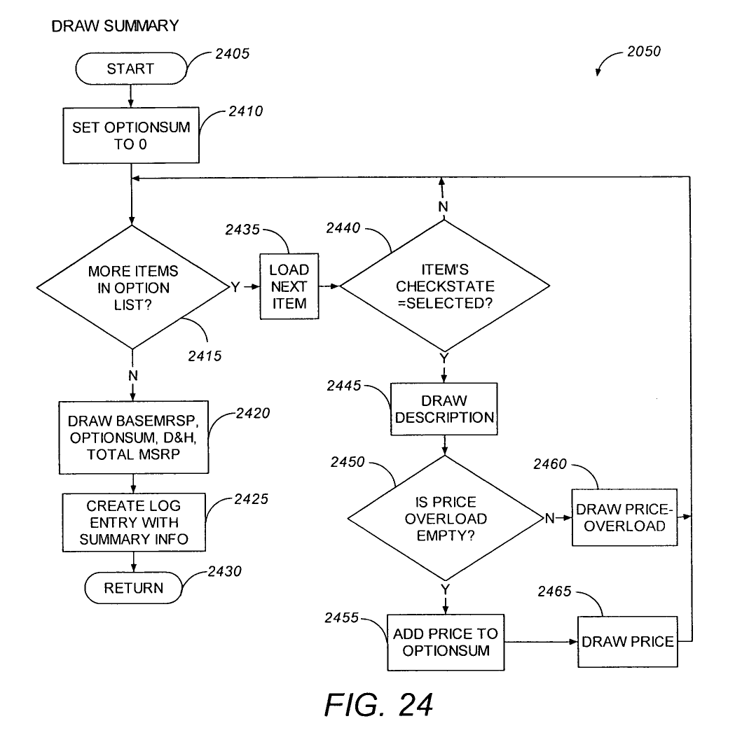

Referring now to FIG. 20, the configurator event loop process 1940 will be described. Beginning at a start state 2005, process 1940 advances to a decision state 2010 to wait for an event to occur. When an event does occur, process 1940 advances to decision state 2015 to determine the event type. If the event type is the user changing the model selection, process 1940 proceeds to state 2020 to load the options and rules into memory. Process 1940 advances to a draw options process 1935 that will be described in conjunction with FIGS. 21a and 21b. Process 1940 returns to decision state 2010 to wait for another event. Referring back to decision state 2015, if the event type is the user selecting an unselected option, process 1940 advances to a select option process 2025 that will be described in conjunction with FIG. 22. Process 1940 then advances to the draw options process 2045. Process 1940 returns to decision state 2010 to wait for another event. Referring back to decision state 2015, if the event type is the user unselecting a selected option, process 1940 advances to an unselect option process 2030 that will be described in conjunction with FIG. 23. Process 1940 then advances to the draw options process 1935. Process 1940 returns to decision state 2010 to wait for another event. Referring back to decision state 2015, if the event type is the user selecting the summary screen, process 1940 advances to state 2035 to display the summary screen. Process 1940 proceeds to a draw summary process 2050 that will be described in conjunction with FIG. 24. Advancing to decision state 2055, process 1940 waits for an event to occur. When an event does occur, process 1940 advances to decision state 2060 to determine the event type. If the event is the user selecting the options screen, process 1940 advances to state 1910 to display options screen. Process 1940 then returns to decision state 2010 to wait for another event. Process 1940 reaches return state 2040 from two states: decision state 2060 when the user exits the configurator; and decision state 2015 when the user exits the configurator. At return state 2040, process 1940 returns to return state 1945 of the launch configurator process 560 (FIG. 19).

Referring now to FIG. 21a, the draw options process 1935 will be described. The draw options process determines which icon should be drawn next to each option, then draws the option on the screen. In order to determine which icon to draw, process 1935 iterates over various option attributes for each option stored in the option object list. Beginning at a start state 2102, process 1935 advances to decision state 2104 to determine if there are more options to be processed in the list. If not, process 1935 returns to the parent process at return state 2106. If there are more options to be processed, process 1935 proceeds to state 2108 to load the next option. Advancing to state 2112, process 1935 sets the option's iconstate to its checkstate.

Process 1935 then begins to loop through the options referenced by the option ids in the original option's requireslist to determine whether all options have a checkstate equal to selected. At decision 2116, process 1935 determines whether there are unprocessed option ids in the requireslist. If so, process 1935 loads the next option at state 2122, and then determines whether its checkstate is equal to selected at decision state 2124. If so, process 1935 returns to decision state 2116 to continue processing items in the requireslist. If it's checkstate is not equal to selected, process 1935 breaks out of the loop and advances to state 2126 to set the original option's iconstate to unselectable. Process 1935 then advances to state 2154 that will be described in conjunction with FIG. 21b.

Referring back to decision state 2116, if there are no more option ids to process in the requirelist, process 1935 advances to decision state 2118 to determine whether the option's requiresonelist is empty. If it is empty, process 1935 advances to state 2154 that will be described in conjunction with FIG. 21b. If the requiresonelist is not empty at decision state 2118 process 1935 begins to loop through the options referenced by the option ids in the original option's requiresonelist to determine whether one of the options in the list has a checkstate equal to selected. At decision state 2120, process 1935 determines whether there are unprocessed option ids in the requiresonelist. If so, process 1935 loads the next option at state 2114, and then determines whether its checkstate is equal to selected at decision state 2110. If not, process 1935 returns to decision state 2120 to continue processing items in the requiresonelist. If the checkstate does equal selected, process 1935 advances to state 2154 that will be described in conjunction with FIG. 21b.

Referring to FIG. 21b, the remainder of process 1935 will now be described. Continuing at a decision state 2154, process 1935 determines whether the options requiredcount is greater than zero. If so, process 1935 sets the option's iconstate to forced at state 2164, and then advances to decision state 2156. If at decision state 2154 the requiredcount is not greater than zero, process 1935 advances to state 2156 to determine whether the options excludedcount is greater than zero. If so, process 1935 sets the option's iconstate to unselectable at state 2166, and then advances to decision state 2158. If at decision state 2156 the item's excludedcount is not greater than zero, process 1935 advances to decision state 2158 to determine whether the option's priceoverload is empty. If not, process 1935 draws priceoverload at state 2168. Otherwise, process 1935 draws the option's price at state 2152. States 2158 and 2168 are both followed by state 2160, in which process 1935 draw's the option's description. Advancing to state 2162, process 1935 draws the appropriate icon based on the value of iconstate. Process 1935 then returns to decision state 2104 (FIG. 21a) to continue processing the option list.

Referring now to FIG. 22, the select option process 2025 will be described. Beginning at a start state 2205, process 2025 advances to state 2210 to set the option's checkstate to selected. Continuing at a decision state 2215, process 2025 determines whether there are unprocessed option ids in the option's excludeslist. If so, process 2025 loads the next item at state 2240 and then increments its excluded count at state 2270. Process 2025 returns to decision state 2215 to determine whether there are more unprocessed option ids in the excludeslist. If not, process 2025 advances to decision state 2220 to determine whether there are unprocessed option ids in the option's includeslist. If so, process 2025 loads the next item at state 2250 and then increments its requiredcount at state 2275. Advancing to state 2245, process 2025 sets the priceoverload of the option loaded to “inc”. Process 2025 returns to decision state 2220 to determine whether there are more unprocessed option ids in the includeslist. If not, process 2025 advances to decision state 2225 to determine whether there are unprocessed option ids in the option's requireslist. If so, process 2025 loads the next item ad state 2255 and then increments its requiredcount at state 2280. Process 2025 returns to decision state 2225 to determine whether there are more unprocessed option ids. If not, process 2025 advances to decision state 2230 to determine whether there are unprocessed option ids in the requiresonelist. If so, process 2025 loads the next item at 2260. Proceeding to decision state 2285, process 2025 determines whether the option just loaded has a checkstate equal to selected. If so, process 2025 increments the item's requiredcount at state 2265 and then returns to the draw options process 1935 (FIG. 20) at return state 2235 If at decision state 2285, the option's checkstate is not equal to selected, process 2025 returns to decision state 2230 to determine whether there are more unprocessed option ids in the option's requiresonelist. If not, process 2025 returns to the draw options process 1935 (FIG. 20) at return state 2235.

Referring now to FIG. 23, the unselect option process 2030 will now be described. Beginning at a start state 2302, process advances to state 2304 to set the option's checkstate to unselected. Proceeding to decision state 2306, process 2030 determines whether there are unprocessed option ids in the option's excludeslist. If so, process 2030 loads the next item at state 2316 and then decrements the item's excludedcount at state 2330. Process 2030 then returns to decision state 2306 to determine if there are more unprocessed option id's in the option's excludeslist. If not, process 2030 advances to decision state 2308 to determine whether there are unprocessed option ids in the option's includeslist. If so, process 2030 loads the next item at state 2320 and then decrements the items' requiredcount at state 2332. Proceeding to decision state 2338, process 2030 determines whether the item's requiredcount is equal to zero. If so, process 2030 sets the item's priceoverload to empty at state 2318 and returns to decision state 2308. If the item's requiredcount is not equal to zero at decision state 2338, process 2030 returns to decision state 2308 to determine whether there are more unprocessed option ids in the option's includeslist. If not, process 2030 advances to decision state 2310 to determine whether there are unprocessed items in the option's requireslist. If so, process 2030 loads the next item at state 2324 and then decrements the item's requiredcount at state 2334. Advancing to decision state 2340, process 2030 determines whether the item's requiredcount is equal to zero. If so, process 2030 sets the item's priceoverload to empty at state 2322 and returns to decision state 2310. If the item's requiredcount is not equal to zero, process 2030 returns to decision state 2310 to determine whether there are more unprocessed option ids in the option's requireslist. If not, process 2030 proceeds to decision state 2312 to determine whether there are unprocessed option ids in the option's requiresonelist. If so, process 2030 loads the next item at state 2326. Advancing to decision state 2342, process 2030 determines whether the item's requiredcount is greater than zero. If not, process 2030 returns to decision state 2312. If so, process 2030 decrements the item's requiredcount at state 2344 and then advances to decision state 2336 to determine whether the item's requiredcount is equal to zero. If so, process 2030 sets the item's priceoverload to empty at state 2328. Process 2030 reaches return state 2314 from one of three states: 1) from decision state 2312 when there are no more unprocessed option ids in the option's requiresonelist; 2) from state 2328; or 3) from decision state 2336 when the item's requiredcount is not equal to zero. At return state 2314, process 2030 returns to the draw options process 1935 (FIG. 20).

Referring to FIG. 24, the draw summary process 2050 will now be described. Beginning at a start state 2405, process 2050 advances to state 2410 to set optionsum to zero. Proceeding to decision state 2415, process 2050 determines whether there are unprocessed options in the option list. If so, process 2050 loads the next item at state 2435 and then determines whether the item's checkstate is equal to selected. If not, process 2050 return to decision state 2415. If the item's checkstate is equal to selected, process 2050 advances to state 2445 to draw the option description. Proceeding to state 2450, process 2050 determines whether the option's priceoverload is empty. If so, the option's price is added to optionsum at state 2455 and process 2050 draws the option's price at state 2465. Process 2050 then returns to decision state 2415. If the option's priceoverload is not empty at decision state 2450, the option's priceoverload is drawn at state 2460 and process 2050 then returns to decision state 2415 to determine whether there are more unprocessed options in the option lists. If not, process 2050 proceeds to state 2420 to draw the product's total price information including: base MSRP, the sum of all options, destination and handling, and total MSRP. Advancing to state 2425, process 2050 creates a log entry on the mobile device that includes the vehicle configured as well as the total price information. Process 2050 returns to decision state 2055 of the configurator event loop process 1940 (FIG. 20) at return state 2430.

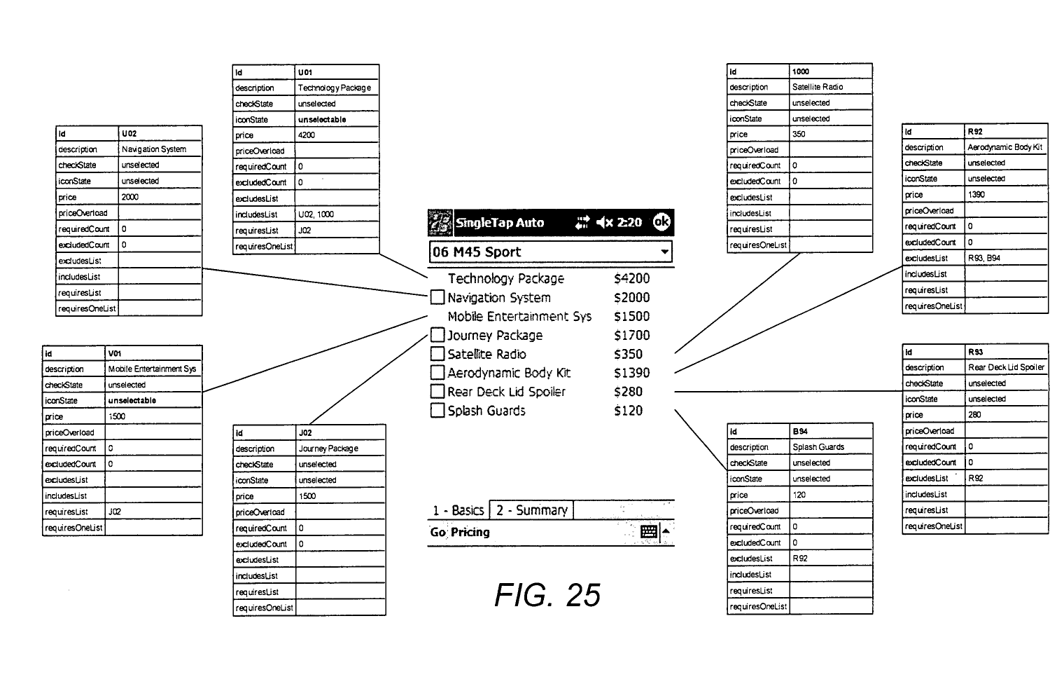

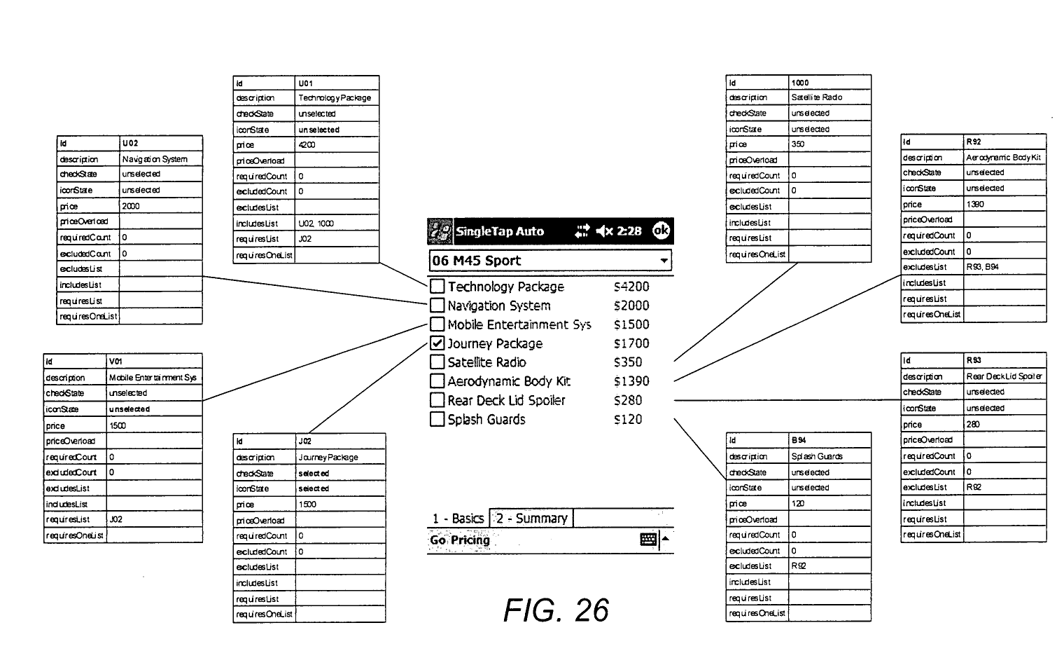

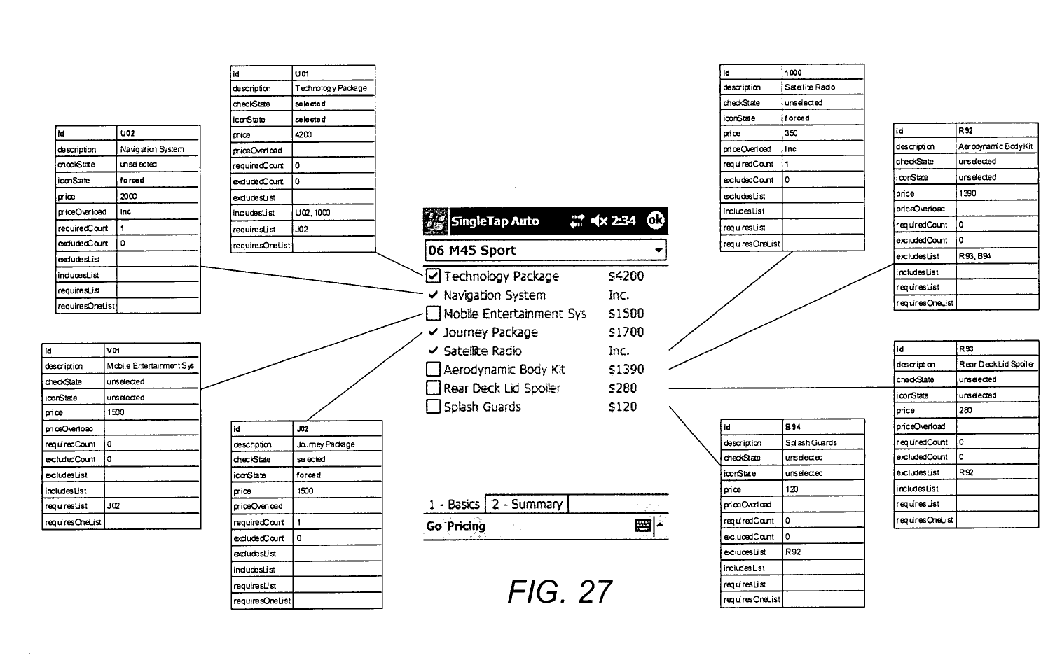

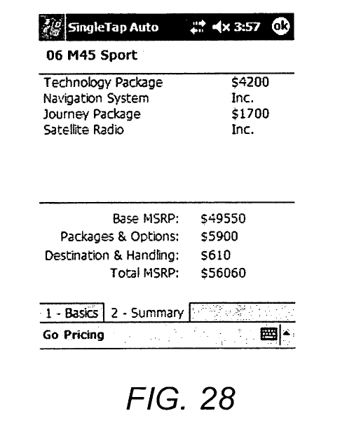

Referring to FIGS. 25-28, a sample usage scenario for the configurator will now be described. FIG. 25 shows the options screen of the configurator as well as the option object data structures, after the options are first drawn in the draw options process 2045 (FIG. 20). FIG. 26 shows the options screen and option object data structures after the user selects the Journey Package option and the select option process 2025 (FIG. 22) and the draw options process 1935 (FIG. 21a, 21b) have both been executed. FIG. 27 shows the option screen and option objects after the user selects the Technology Package option and the select option process 2025 (FIG. 22) and draw options process 1935 (FIG. 21a, 21b) have both been executed. FIG. 28 shows the summary screen after the user selects summary screen and the draw summary process 2050 (FIG. 24) has been executed.

11. Application Usage Logging

In certain embodiments, the MSA application modules record all user functions into the mobile device usage log database. For example, the comparisons module records the models compared, the configurator module records the model and options selected, and the inventory module records the individual products viewed. This log information is sent to the MSA server during the sync process and can be viewed using the MSA server report management module.

12. Expandable Text Display

The expandable text user interface element provides a host application with a method for reducing text to an abbreviated form, displaying the abbreviated form, and then allowing the user to perform some action to view the complete text. Once the complete text is displayed, it disappears automatically after an interval of time proportional to the length of the full text. The full text may also be dismissed by the user manually before it disappears automatically.

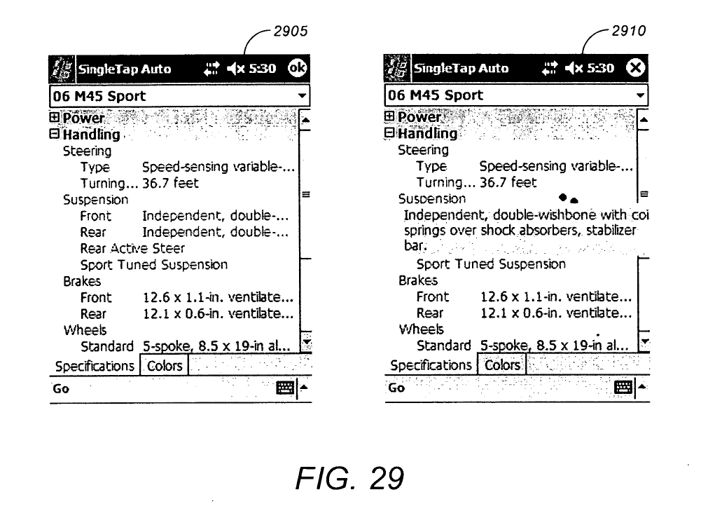

In order to display the abbreviated text, the host application determines which text to be abbreviated. In one embodiment, the host application may need to display text in an area where it won't fit, such as in the cell of a grid. In such an embodiment, the host application calculates the abbreviation as the portion of the text, which combined with an ellipsis, will fit in the cell. In another embodiment, the host application determines whether to abbreviate text by comparing text to be displayed against a known database of abbreviations and the words or phrases the abbreviations represent. In this case, words in the text to be displayed that match entries in the database would automatically be replaced with the abbreviation in the database entry, along with an ellipsis. In both cases, the ellipsis provides the user with a visual indicator that the text is an abbreviation and can be expanded. Note that in other embodiments, other indicators could be used such as stylized text, borders, backgrounds, or icons. Examples of abbreviated text in the MSA mobile application are shown on screen 2905 of FIG. 29. In these examples, the host automatically abbreviates text to fit in constrained grid cells, and uses a trailing ellipsis to indicate text is abbreviated and can be expanded.

When the user selects the abbreviated text, the host application displays the full text in a display area that covers, or is located very close to the original abbreviated text. The size of the expanded text area is calculated based on the length of the full text. An example of the expanded text display is shown on mobile device screen 2910 of FIG. 29. The expanded text display area will automatically disappear after an amount of time calculated based on the length of the text. For example, in one embodiment the length of time may be 600 milliseconds plus 50 milliseconds for each character of text. In addition to disappearing automatically, the user may also dismiss the expanded text display by selecting another function in the application. In one embodiment, this action may be the user tapping the screen with a stylus.

### III. MSA Server Functionality

The MSA server retrieves and stores data from external sources, handles all communications with mobile devices, and provides various system and data management functions. Referring to FIG. 2, this section will describe the following functions of the MSA server: 1) data retrieval and storage, 2) location and user management, 3) mobile device application management and installation, 4) mobile device application and data updates, 5) product information management, 6) inventory management, 7) usage reporting, and 8) broadcast messaging.

1. Data Retrieval and Storage

The remote data retrieval interface 240 of the MSA server retrieves data from remote servers and stores it in the data repository 272. The remote data retrieval interface can retrieve data in at least three ways: 1) it can use server connection parameters stored in the location profile to automatically connect to a remote server and retrieve data with a specific frequency; 2) it can use a connection script program to automatically connect to a remote server and retrieve data; and 3) it can allow inbound connections from a remote server to deliver data. For example, in an embodiment where inventory information is stored on a server at an individual retail location, the server address, login information, and connection schedule or frequency may be stored in the location profile. The data retrieval module then uses this information to automatically retrieve the information and store it in the product inventory database. In another embodiment, where product related data is located on a remote server, such comparison data provided by a third party, a programmer may be required to write a connection script to retrieve the appropriate data. In this case, the data retrieval module would use the script to retrieve the data and then store it in the product info database 268.

2. Location and User Management

The location and user management functions are provided by the location management module 244 and the user management module 246. In various embodiments, different sets of these functions may be available to MSA provider admin users, manufacturer admin users, and location admin users, through the MSA provider admin interface 236, manufacturer admin interface 234, and location admin interface 232, respectively.

The location management functions support the creation, modification, and deletion of locations. For a given location, the location management module supports the assignment and modification of the following attributes: location identity; a list of associated users; parameters used for the remote data retrieval module 240 to access a remote server containing data specific to the location; the version of MSA mobile device installation package for associated users; a set of user permissions associated users; a set of products offered for sale at the location; as well as product related attributes, such as a set of competing products for products offered at the location. The invention anticipates the location management module will support the assignment and modification of additional location attributes as future location specific functions and data are added to the MSA system.

The user management functions support the creation, modification, and deletion of users within the MSA system. For a given user, the user management module supports the assignment and modification of the following attributes: user identity, device login information, a location, a set of user permissions, as well as a set of products available to the user. The invention anticipates the user management module will support the assignment and modification of additional user attributes as future user specific functions and data are added to the MSA system.

3. Mobile Device Application Management and Installation

The software update management module 255 provides mobile device software management functionality through the MSA provider admin interface 236. The software update management module allows the user to add mobile device installation packages to the MSA server for storage in the software updates database 266. When an installation package is added, the user can include a version number as well as a target platform (e.g. Windows Mobile 5.0), and can additionally associate the installation package with a plurality of locations.

The device setup interface 228 allows mobile devices to retrieve and install the appropriate installation package. The device setup interface accepts inbound connections from mobile device web browsers and displays an authentication web page prompting the user for valid login information. When the mobile device user submits the login, the device setup interface authenticates the user against the user profile database and, if successful, looks up the corresponding location profile. Next, the device setup interface determines the appropriate installation package to deliver based on device platform information in the device web browser request, as well as the version associated with the location profile. The installation package is then delivered to the device where it can be executed by the user.

4. Mobile Device Application and Data Updates

The MSA device sync interface 230 provides application software and data updates to mobile devices running the MSA mobile device application. The device sync interface accepts incoming connections and supports the sync process 555 (FIG. 8).

5. Product Information Management

The product information management functions are provided by the product info management module 250. In various embodiments, different sets of these functions may be available to MSA provider admin users, and manufacturer admin users, through the MSA provider admin interface 236, and manufacturer admin interface 234, respectively.

The product information management module supports the addition, modification, and deletion of products and associated product data within the system. Additionally, it allows product models and data to be associated with a plurality of locations. In an example embodiment, when a new product is released, the product information management module would be used by a manufacturer admin user to add the new product to the system, associate a list of competing products to be used in product comparisons, and to associate the product with all the retailers where it will be offered.

6. Inventory Management

The inventory management functions are provided by the inventory management module 248. In various embodiments, different sets of these functions may be available to MSA provider admin users, and manufacturer admin users, through the MSA provider admin interface 236, and manufacturer admin interface 234, respectively.

The inventory management module allows a user to generate various inventory reports based on inventory attributes, and change attributes of individual products in inventory such as location, notes or status. For example, in an embodiment where the products are automobiles, the inventory management module may be used to generate a report of all the vehicles on a certain lot for use in verifying physical inventory. In the same automotive embodiment, a sales manager may move a vehicle and use the inventory management module to change the location in the MSA system, which would subsequently be reflected on the mobile devices of all the salespeople at the location.

7. Usage Reporting

Usage reporting functions are provided by the report management module 254. In various embodiments, different sets of these functions may be available to MSA provider admin users, manufacturer admin users, and location admin users, through the MSA provider admin interface 236, manufacturer admin interface 234, and location admin interface 232, respectively. The usage reporting module generates reports based on usage data retrieved from the mobile devices. In one embodiment, it could be used for sales training purposes. For example, a manufacturer representative may generate a report that shows which comparisons are most often viewed in order to develop future sales training materials.

8. Broadcast Messaging

Messaging functions are provided by the messaging management module 252. In various embodiments, different sets of these functions may be available to MSA provider admin users, manufacturer admin users, and location admin users, through the MSA provider admin interface 236, manufacturer admin interface 234, and location admin interface 232, respectively. The messaging module allows the user to create and send a message to a group of mobile device users, as well as monitor the rate at which the messages are read. This functionality would be used to send broadcast type messages. For example, a sales manager may send a message announcing a special bonus commission; or a manufacturer may send a message including a product announcement.

### CONCLUSION

While specific blocks, sections, devices, functions and modules may have been set forth above, a skilled technologist will realize that there are many ways to partition the system, and that there are many parts, components, modules or functions that may be substituted for those listed above.

While the above detailed description has shown, described, and pointed out the fundamental novel features of the invention as applied to various embodiments, it will be understood that various omissions and substitutions and changes in the form and details of the system illustrated may be made by those skilled in the art, without departing from the intent of the invention.

1. A system for applying databases to provide product related information to mobile users, the system comprising:
a wireless communications network configured to provide coverage at retail locations;
a portable computing device configured to be intermittently connected to the wireless communications network, wherein the portable computing device includes
a data repository configured to store inventory information,
a software application comprising various modules including
an inventory module configured to display inventory information based on the data repository, and
a communications module configured to retrieve updates to the portable device software application and inventory information;
a server computer having a network connection to the wireless communications network, and at least one external server computer, the server computer comprising:
a server data repository configured to store (1) location profiles for each location where portable devices are used, each location profile including identifying information and information required to access an inventory system of a particular location, (2) portable device user profiles including identifying information, each user profile being associated with a location profile, and (3) inventory information retrieved from the inventory system of the particular location,
a communications module configured to connect with the portable computing device so as to provide updates,
a location module configured to manage location profiles,
a user module configured to manage portable device profiles, and
an inventory module configured to (1) retrieve inventory information from the inventory system of the particular location using access information stored in the location profile, (2) store inventory information in the server data repository, and (3) display inventory information; and
a computing device configured to remotely use the user module and the location module located on the server computer.

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. The system defined in claim 1, wherein the portable device application includes one or more modules configured to display product related information.

24. (canceled)

25. (canceled)

26. (canceled)

27. The system defined in claim 1, wherein the portable device data repository is further configured to store product related information.

28. The system defined in claim 1, wherein the server data repository is further configured to store product related information retrieved from various sources including data sources located on the external server computer.

29. The system defined in claim 27, wherein the server computer includes one or more product data modules configured to control what product information is sent to portable computing devices.

30. (canceled)

31. The system defined in claim 23, wherein the portable device communications module retrieves updates to product related information.

32. The system defined in claim 23, wherein the server communications module sends updates to product related information.

33. (canceled)

34. The system defined in claim 1, wherein one of the application modules is configured to configure and price a product by displaying a plurality of product options, wherein valid combinations of such product options are determined by a set of fixed rules.

35. (canceled)

36. (canceled)

37. (canceled)

38. (canceled)

39. (canceled)

40. (canceled)

41. (canceled)

42. (canceled)

43. (canceled)

44. (canceled)

45. (canceled)

46. (canceled)

47. (canceled)

48. (canceled)

49. (canceled)

50. (canceled)

51. (canceled)

52. (canceled)

53. (canceled)

54. (canceled)

55. (canceled)

56. (canceled)

57. The system defined in claim 1, wherein one of the user profiles stored in the server data repository includes a list of modules and functions authorized for use on a portable computing device associated with the particular location.

58. The system defined in claim 1, wherein portable device functionality is limited to that specified in the location profile.

59. (canceled)

60. The system defined in claim 1, wherein portable device functionality is limited to that specified in one of the user profiles that is associated with the particular location.

61. A system for configuring and calculating the price of a product with multiple options, the system comprising:
a portable computing device with a wireless data communications capability comprising
a data repository containing product models, available product options, and rules that define relationships between the product options, and
a software application configured to allow a user to select the various options for a particular product, such that at all times during use, all the available options are visible, but only options that represent valid selections based on the rules can be selected.

62. (canceled)

63. (canceled)

64. (canceled)

65. (canceled)

66. A method of configuring and calculating the price of a product with multiple options, the method comprising:
operating a portable computing device with a wireless data communications capability;
providing a data repository containing product models, available product options, and rules that define relationships between the product options; and
selecting the various options for a particular product, wherein at all times during use, all the available options are visible, but only options that represent valid selections based on the rules can be selected.

67. A method of displaying text in a complete and abbreviated form operating in a system comprising a portable computing device with a display and a user input device and including an application executing on the portable device that designates a plurality of display areas on the screen to display text and a data storage comprising a plurality of text items to be displayed such that some of the text items are too long to be drawn in a display area, the method comprising:
displaying only a portion of text that, in conjunction with an abbreviation marker, fits in the display area;
selecting the display area; and
displaying a complete form of the text in a larger display area, comprising
dynamically calculating the larger display's size based on the length of the complete text, and
automatically removing the complete form of the text from the larger display area after an amount of time proportionate to the length of the complete text.

68. (canceled)

69. (canceled)

70. (canceled)

71. A system for providing product related information to mobile users in a retail location, the system comprising:
a wireless communications network configured to provide coverage at retail location; and
a plurality of portable computing devices, wherein each portable computing device is configured to be intermittently connected to the wireless communications network, and wherein each portable computing device includes
a means for entering data,
a data repository configured to store inventory information, data entered by the user, product related information, and application usage information, and
a software application comprising various modules including
an inventory module configured to display inventory information based on the data repository,
a product data module configured to display product related information, and
a communications module configured to (1) retrieve updates to the portable device application, (2) retrieve updates to inventory data, (3) retrieve updates to product related information, (4) retrieve data stored on another portable computing device, (5) send information entered by the user, and (6) send application usage information.

72. (canceled)

73. (canceled)

74. (canceled)

75. (canceled)

76. (canceled)

77. (canceled)

78. (canceled)

79. (canceled)

80. (canceled)

81. (canceled)

82. (canceled)

83. (canceled)

84. (canceled)

85. (canceled)

86. (canceled)

87. (canceled)

88. (canceled)

89. A system for providing product related information to mobile users in a plurality of retail locations, the system comprising:
a wireless communications network configured to provide coverage at retail locations; and
a server computer having a network connection to the wireless communications network, and at least one external server computer, the server computer comprising:
a server data repository configured to store (1) location profiles for each location where portable devices are used, each location profile including identifying information and information required to access an inventory system of a particular location, (2) portable device user profiles including identifying information, each user profile being associated with a location profile, and (3) inventory information retrieved from the inventory system of the particular location,
a communications module configured to connect with the portable computing device so as to send inventory information updates,
a location module configured to manage location profiles,
a user module configured to manage portable device profiles, and
an inventory module configured to (1) retrieve inventory information from the inventory systems of the particular location using access information stored in the location profile, (2) store inventory information in the data repository, and (3) display inventory data.

90. (canceled)

91. (canceled)

92. (canceled)

93. (canceled)

94. (canceled)

95. (canceled)

96. (canceled)

97. (canceled)

98. The system defined in claim 89, wherein the server data repository is further configured to store product related information retrieved from various sources including data sources located on the external server computer.

99. (canceled)

100. (canceled)

101. (canceled)

102. The system defined in claim 98, wherein the server computer includes one or more product data modules configured to control the product related information that is sent to portable computing devices.

103. (canceled)

104. The system defined in claim 98, wherein the server communications module sends updates of the product related information.

105. (canceled)

106. (canceled)

107. (canceled)

108. (canceled)

109. (canceled)

110. (canceled)

111. A method of prompting a user for a selection of an item from a set of items defined by a database query, and maintaining a currently selected item, the method operating in a system comprising a portable computing device with a display, a user input device, data storage and including an application executing on the portable device, the method comprising:
designating a currently selected item from a set of items in a database defined by a query;
displaying the currently selected item;
receiving a selected function to change the currently selected item;
displaying available choices associated with the currently selected item in a hierarchical menu structure;
receiving a newly selected item from the hierarchical menu structure;
displaying the newly selected item in an item display area on the display; and
storing the newly selected item.

112. (canceled)

113. (canceled)

114. (canceled)
